(19) United States
(12) Patent Application Publication
(10) Pub. No.: US 2025/0184764 A1
(43) Pub. Date: Jun. 5, 2025

(54) INFERENCE ERROR INFORMATION FEEDBACK FOR MACHINE LEARNING-BASED INFERENCES

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/840,406

(22) PCT Filed: Apr. 6, 2023
(86) PCT No.: PCT/CN2023/090769

§ 371 Date: Aug. 21, 2024

(30) Foreign Application Priority Data
Apr. 27, 2022 (WO) PCT/CN2022/089457

(51) Int. Cl. H04W 24/02; H04W 72/542

(52) U.S. Cl. CPC H04W 24/02; H04W 72/542

(57) ABSTRACT

Methods, systems, and devices for wireless communications are described. A user equipment (UE) may receive control signaling indicating a configuration for the UE to perform a machine learning-based inference (e.g., based on a machine learning model) for predicting a characteristic of at least one resource, at least one communication beam, or at least one communication channel. The characteristic may be associated with a spatial domain, a time domain, a frequency domain, or any combination thereof. In accordance with the configuration, the UE may perform the machine learning-based inference for the characteristic. The UE may also perform a measurement of the characteristic (e.g., an actual measurement). The UE may also transmit, in accordance with a triggering condition, an indication of a difference between the machine learning-based inference and the measurement of the characteristic.

### CROSS REFERENCES

The present application is a 371 national stage filing of International PCT Patent Application No. PCT/CN2023/090769 by LI et al., entitled “INFERENCE ERROR INFORMATION FEEDBACK FOR MACHINE LEARNING-BASED INFERENCES,” filed Apr. 26, 2023, which claims priority to International PCT Patent Application No. PCT/CN2022/089457 by LI et al., entitled “INFERENCE ERROR INFORMATION FEEDBACK FOR MACHINE LEARNING-BASED INFERENCES,” filed Apr. 27, 2022, each of which is assigned to the assignee hereof, and each of which is expressly incorporated herein.

### FIELD OF TECHNOLOGY

The following relates to wireless communications, including inference error information feedback for machine learning-based inferences.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support inference error information feedback for machine learning-based inferences.

A method for wireless communication at a user equipment (UE) is described. The method may include receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain, performing the machine learning-based inference for the characteristic of the at least one resource, the at least one communication beam, or the at least one communication channel in accordance with the configuration, obtaining a measurement of the characteristic of the at least one resource, the at least one communication beam, or the at least one communication channel, and transmitting, in accordance with a triggering condition, an indication of a difference between the machine learning-based inference and the measurement of the characteristic for the at least one resource, the at least one communication beam, or the at least one communication channel.

An apparatus for wireless communication at a UE is described. The apparatus may include at least one processor, memory coupled (e.g., operatively, communicatively, functionally, electronically, or electrically) to the at least one processor, and instructions stored in the memory. The instructions may be executable by the at least one processor (e.g., directly, indirectly, after pre-processing, without pre-processing) to cause the apparatus to receive control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain, perform the machine learning-based inference for the characteristic of the at least one resource, the at least one communication beam, or the at least one communication channel in accordance with the configuration, obtain a measurement of the characteristic of the at least one resource, the at least one communication beam, or the at least one communication channel, and transmit, in accordance with a triggering condition, an indication of a difference between the machine learning-based inference and the measurement of the characteristic for the at least one resource, the at least one communication beam, or the at least one communication channel.

Another apparatus for wireless communication at a UE is described. The apparatus may include means for receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain, means for performing the machine learning-based inference for the characteristic of the at least one resource, the at least one communication beam, or the at least one communication channel in accordance with the configuration, means for obtaining a measurement of the characteristic of the at least one resource, the at least one communication beam, or the at least one communication channel, and means for transmitting, in accordance with a triggering condition, an indication of a difference between the machine learning-based inference and the measurement of the characteristic for the at least one resource, the at least one communication beam, or the at least one communication channel.

A non-transitory computer-readable medium storing code for wireless communication at a UE is described. The code may include instructions executable by at least one processor (e.g., directly, indirectly, after pre-processing, without pre-processing) to receive control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain, perform the machine learning-based inference for the characteristic of the at least one resource, the at least one communication beam, or the at least one communication channel in accordance with the configuration, obtain a measurement of the characteristic of the at least one resource, the at least one communication beam, or the at least one communication channel, and transmit, in accordance with a triggering condition, an indication of a difference between the machine learning-based inference and the measurement of the characteristic for the at least one resource, the at least one communication beam, or the at least one communication channel.

In some examples of the method, apparatuses, and non-transitory computer-readable medium described herein, performing the machine learning-based inference for the characteristic and obtaining the measurement of the characteristic may include operations, features, means, or instructions for identifying, based at least in part on the machine learning-based inference, a first set of identifiers corresponding to one or more resources having a highest predicted measurement of the characteristic of the at least one communication beam or the at least on communication channel, and identify, based at least in part on obtaining the measurement of the characteristic, a second set of identifiers corresponding to tone or more resources having a highest actual predicted measurement of the characteristic of the at least one resource, the at least one communication beam, or the at least one communication channel.

In some examples of the method, apparatuses, and non-transitory computer-readable medium described herein, transmitting an indication of the difference between the machine learning-based inference and the measurement of the characteristic may include operations, features, means, or instructions for transmitting one or more of: the first set of identifiers, the second set of identifiers, an indication of a difference between the first set of identifiers and the second set of identifiers, or any combination thereof.

In some examples of the method, apparatuses, and non-transitory computer-readable medium described herein, obtaining the measurement of the characteristic may include operations, features, means, or instructions for obtaining a virtual measurement of a virtual resource associated with the characteristic of the at least one resource, the at least one communication beam, or the at least one communication channel, wherein the virtual resource is a non-transmitted resource.

In some examples of the method, apparatuses, and non-transitory computer-readable medium described herein, performing the machine learning-based inference for the characteristic of the at least one resource, the at least one communication beam, or the at least one communication channel may include operations, features, means, or instructions for applying a machine learning model to at least one historic value of the characteristic to predict at least one later value of the characteristic, where the machine learning-based inference includes the predicted at least one later value of the characteristic.

In some examples of the method, apparatuses, and non-transitory computer-readable medium described herein, receiving the control signaling may include operations, features, means, or instructions for receiving an instruction to report the at least one historic value of the characteristic and the predicted at least one later value of the characteristic.

In some examples of the method, apparatuses, and non-transitory computer-readable medium described herein, transmitting the indication of the difference between the machine learning-based inference and the measurement of the characteristic may include operations, features, means, or instructions for transmitting the at least one historic value of the characteristic and the predicted at least one later value of the characteristic in accordance with the received instruction.

In some examples of the method, apparatuses, and non-transitory computer-readable medium described herein, the at least one historic value of the characteristic includes a time series of a set of multiple historic values of the characteristic.

Some examples of the method, apparatuses, and non-transitory computer-readable medium described herein may further include operations, features, means, or instructions for receiving an indication of a length of the time series of the set of multiple historic values of the characteristic.

In some examples of the method, apparatuses, and non-transitory computer-readable medium described herein, transmitting the indication of the difference between the machine learning-based inference and the measurement of the characteristic may include operations, features, means, or instructions for transmitting an indication of a length of the time series of the set of multiple historic values of the characteristic.

In some examples of the method, apparatuses, and non-transitory computer-readable medium described herein, performing the machine learning-based inference for the characteristic of the at least one resource, the at least one communication beam, or the at least one communication channel may include operations, features, means, or instructions for applying a machine learning model to at least one first value of the characteristic associated with a first set one or more reference signal resource identifiers or synchronization signal block resource identifiers to predict at least one second value of the characteristic associated with a second set of one or more reference signal resource identifiers or synchronization signal block resource identifiers, where the machine learning-based inference includes the predicted at least one second value of the characteristic.

In some examples of the method, apparatuses, and non-transitory computer-readable medium described herein, the first set of one or more reference signal resource identifiers or synchronization signal block resource identifiers may be spatially different than the second set of one or more reference signal resource identifiers or synchronization signal block resource identifiers.

In some examples of the method, apparatuses, and non-transitory computer-readable medium described herein, the first set of one or more reference signal resource identifiers or synchronization signal block resource identifiers and the second set of one or more reference signal resource identifiers or synchronization signal block resource identifiers may be associated with different bandwidth parts or serving cells.

In some examples of the method, apparatuses, and non-transitory computer-readable medium described herein, receiving the control signaling may include operations, features, means, or instructions for receiving an instruction to report the at least one first value of the characteristic associated with the first set one or more reference signal resource identifiers or synchronization signal block resource identifiers and the at least one second value of the characteristic associated with the second set of one or more reference signal resource identifiers or synchronization signal block resource identifiers.

In some examples of the method, apparatuses, and non-transitory computer-readable medium described herein, transmitting the indication of the difference between the machine learning-based inference and the measurement of the characteristic may include operations, features, means, or instructions for transmitting the at least one first value of the characteristic associated with the first set one or more reference signal resource identifiers or synchronization signal block resource identifiers and the at least one second value of the characteristic associated with the second set of one or more reference signal resource identifiers or synchronization signal block resource identifiers.

Some examples of the method, apparatuses, and non-transitory computer-readable medium described herein may further include operations, features, means, or instructions for receiving an indication of the triggering condition.

In some examples of the method, apparatuses, and non-transitory computer-readable medium described herein, the triggering condition occurs when the difference between the machine learning-based inference and the measurement of the characteristic satisfies a threshold.

Some examples of the method, apparatuses, and non-transitory computer-readable medium described herein may further include operations, features, means, or instructions for transmitting a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

In some examples of the method, apparatuses, and non-transitory computer-readable medium described herein, and the method, apparatuses, and non-transitory computer-readable medium may include further operations, features, means, or instructions for a signal strength associated with the at least one communication channel or the at least one communication beam, a change in signal strength associated with the at least one communication channel or the at least one communication beam, an explicit channel characteristic associated with the at least one resource, the at least one communication beam, or the at least one communication channel, an angular characteristic associated with the at least one resource, the at least one communication beam, or the at least one communication channel, a location of the UE during communication over the at least one resource, the at least one communication beam, or the at least one communication channel, a set of one or more UE receive beams used to communicate over the at least one resource, the at least one communication beam, or the at least one communication channel, a bandwidth part identifier associated with communicating over the at least one resource, the at least one communication beam, or the at least one communication channel, a serving cell identifier associated with communicating over the at least one resource, the at least one communication beam, or the at least one communication channel, a central frequency associated with communicating over the at least one resource, the at least one communication beam, or the at least one communication channel, or a numerology associated with communicating over the at least one resource, the at least one communication beam, or the at least one communication channel.

In some examples of the method, apparatuses, and non-transitory computer-readable medium described herein, the characteristic may be defined with respect to a set of one or more reference signal resource sets or one or more synchronization signal block resource sets.

In some examples of the method, apparatuses, and non-transitory computer-readable medium described herein, an application layer protocol, a radio resource control layer, or a medium access control layer, the indication including physical layer information associated with the machine learning-based inference.

In some examples of the method, apparatuses, and non-transitory computer-readable medium described herein, the indication of the difference between the machine learning-based inference and the measurement of the characteristic may be transmitted in a channel state information report via a physical layer uplink control information transmission.

In some examples of the method, apparatuses, and non-transitory computer-readable medium described herein, transmitting the indication of the difference between the machine learning-based inference and the measurement of the characteristic may include operations, features, means, or instructions for transmitting an indication of a state of one or more hidden layers of a machine learning model associated with the machine learning-based inference.

A method for wireless communication at a network entity is described. The method may include transmitting control signaling indicating a configuration for a UE to perform a machine learning-based inference for a characteristic of at least one resource, at least one communication beam, or at least one communication channel and receiving, in accordance with a triggering condition, an indication of a difference between the machine learning-based inference and a measurement of the characteristic for the at least one resource, the at least one communication beam, or the at least one communication channel at the UE.

An apparatus for wireless communication at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to transmit control signaling indicating a configuration for a UE to perform a machine learning-based inference for a characteristic of at least one resource, at least one communication beam, or at least one communication channel and receive, in accordance with a triggering condition, an indication of a difference between the machine learning-based inference and a measurement of the characteristic for the at least one resource, the at least one communication beam, or the at least one communication channel at the UE.

Another apparatus for wireless communication at a network entity is described. The apparatus may include means for transmitting control signaling indicating a configuration for a UE to perform a machine learning-based inference for a characteristic of at least one resource, at least one communication beam, or at least one communication channel and means for receiving, in accordance with a triggering condition, an indication of a difference between the machine learning-based inference and a measurement of the characteristic for the at least one resource, the at least one communication beam, or the at least one communication channel at the UE.

A non-transitory computer-readable medium storing code for wireless communication at a network entity is described. The code may include instructions executable by at least one processor (e.g., directly, indirectly, after pre-processing, without pre-processing) to transmit control signaling indicating a configuration for a UE to perform a machine learning-based inference for a characteristic of at least one resource, at least one communication beam, or at least one communication channel and receive, in accordance with a triggering condition, an indication of a difference between the machine learning-based inference and a measurement of the characteristic for the at least one resource, the at least one communication beam, or the at least one communication channel at the UE.

In some examples of the method, apparatuses, and non-transitory computer-readable medium described herein, the indication of the difference between the machine learning-based inference and the measurement of the characteristic may include one or more of: a first set of identifiers corresponding to one or more resources having a highest predicted measurement of the characteristic of the at least one resource, the at least one communication beam, or the at least one communication channel, a second set of identifiers corresponding to one or more resources having a highest actual predicted measurement of the characteristic of the at least one resource, the at least one communication beam, or the at least one communication channel, an indication of a difference between the first set of identifier sand the second set of identifiers, or any combination thereof.

In some examples of the method, apparatuses, and non-transitory computer-readable medium described herein, the measurement of the characteristic may be a virtual measurement of a virtual resource associated with the characteristic of the at least one resource, the at least one communication beam, or the at least one communication channel, wherein the virtual resource is a non-transmitted resource.

In some examples of the method, apparatuses, and non-transitory computer-readable medium described herein, transmitting the control signaling may include operations, features, means, or instructions for transmitting an instruction to report the at least one historic value of the characteristic and the predicted at least one later value of the characteristic.

In some examples of the method, apparatuses, and non-transitory computer-readable medium described herein, receiving the indication of the difference between the machine learning-based inference and the measurement of the characteristic may include operations, features, means, or instructions for receiving the at least one historic value of the characteristic and the predicted at least one later value of the characteristic in accordance with the transmitted instruction.

In some examples of the method, apparatuses, and non-transitory computer-readable medium described herein, and the method, apparatuses, and non-transitory computer-readable medium may include further operations, features, means, or instructions for transmitting an instruction to report the at least one historic value of the characteristic and the predicted at least one later value of the characteristic.

Some examples of the method, apparatuses, and non-transitory computer-readable medium described herein may further include operations, features, means, or instructions for transmitting an indication of a length of the time series of the set of multiple historic values of the characteristic.

In some examples of the method, apparatuses, and non-transitory computer-readable medium described herein, receiving the indication of the difference between the machine learning-based inference and the measurement of the characteristic may include operations, features, means, or instructions for receiving an indication of a length of the time series of the set of multiple historic values of the characteristic.

In some examples of the method, apparatuses, and non-transitory computer-readable medium described herein, transmitting the control signaling may include operations, features, means, or instructions for transmitting an instruction to report at least one first value of the characteristic associated with a first set of one or more reference signal resource identifiers or synchronization signal block resource identifiers and at least one predicted second value of the characteristic associated with a second set of one or more reference signal resource identifiers or synchronization signal block resource identifiers, where the machine learning-based inference includes the at least one predicted second value of the characteristic.

In some examples of the method, apparatuses, and non-transitory computer-readable medium described herein, receiving the indication of the difference between the machine learning-based inference and the measurement of the characteristic may include operations, features, means, or instructions for receiving the at least one first value of the characteristic associated with the first set of one or more reference signal resource identifiers or synchronization signal block resource identifiers and the at least one predicted second value of the characteristic associated with the second set of one or more reference signal resource identifiers or synchronization signal block resource identifiers.

Some examples of the method, apparatuses, and non-transitory computer-readable medium described herein may further include operations, features, means, or instructions for transmitting an indication of the triggering condition.

Some examples of the method, apparatuses, and non-transitory computer-readable medium described herein may further include operations, features, means, or instructions for receiving a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

### BRIEF DESCRIPTION OF THE DRAWINGS

FIG. 1 illustrates an example of a wireless communications system that supports inference error information feedback for machine learning-based inferences in accordance with one or more aspects of the present disclosure.

FIG. 2 illustrates an example of a wireless communications system that supports inference error information feedback for machine learning-based inferences in accordance with one or more aspects of the present disclosure.

FIG. 3 illustrates an example of a system that supports inference error information feedback for machine learning-based inferences in accordance with one or more aspects of the present disclosure.

FIG. 4 illustrates an example of a process flow that supports inference error information feedback for machine learning-based inferences in accordance with one or more aspects of the present disclosure.

FIGS. 5 and 6 show block diagrams of devices that support inference error information feedback for machine learning-based inferences in accordance with one or more aspects of the present disclosure.

FIG. 7 shows a block diagram of a communications manager that supports inference error information feedback for machine learning-based inferences in accordance with one or more aspects of the present disclosure.

FIG. 8 shows a diagram of a system including a device that supports inference error information feedback for machine learning-based inferences in accordance with one or more aspects of the present disclosure.

FIGS. 9 and 10 show block diagrams of devices that support inference error information feedback for machine learning-based inferences in accordance with one or more aspects of the present disclosure.

FIG. 11 shows a block diagram of a communications manager that supports inference error information feedback for machine learning-based inferences in accordance with one or more aspects of the present disclosure.

FIG. 12 shows a diagram of a system including a device that supports inference error information feedback for machine learning-based inferences in accordance with one or more aspects of the present disclosure.

FIGS. 13 through 16 show flowcharts illustrating methods that support inference error information feedback for machine learning-based inferences in accordance with one or more aspects of the present disclosure.

### DETAILED DESCRIPTION

In wireless communications systems, a user equipment (UE) or a network entity may implement a machine learning model to predict conditions of a resource, a channel, or a beam for predictive beam management between the UE and the network entity. To develop the machine learning model, the network may implement a training scheme (e.g., for time domain, spatial domain, or frequency domain), collect data (e.g., field L1-reference signal received power (RSRP) or signal to noise ratio (SINR) measurements), train the machine learning model based on the data, and implement the model. However, the collected data may not accurately train the machine learning model to account for some outlier conditions or corner cases, and collecting data at the network for outlier cases may not be efficient. For these outlier conditions, the difference between the machine learning model predicted value and the actual value may be unacceptably high. In such cases, the machine learning model may fail.

To further train a machine learning model at the network, a network entity may configure a UE to perform inferences (such as predictions) for one or more resource, channel, or beam characteristics, then compare the inferences to actual measurements of the resource, channel, or beam characteristics to identify errors in the machine learning model and report the errors to the network entity (e.g., in addition to traditional beam management). For example, the network entity may create the machine learning model (e.g., based on common cases or conditions) and deploy the machine learning model to the UE, then configure the UE to report machine learning-based inference errors. The UE may perform inferences for an indicated characteristic using the machine learning model in the spatial domain, time domain, or frequency domain. The UE may perform an actual measurement of the characteristic with respect to one or more real or virtual resources in the spatial domain, the time domain, and/or the frequency domain, and may determine the error between the machine learning model predicted inference and the actual measurement. The UE may report the inference errors to the network entity in order to update the machine learning model. In some cases, the UE may report the inference error based on a trigger, such as if the inference error satisfies (e.g., exceeds) a threshold value. In some cases, the UE may report its capability to provide feedback about inference errors for a machine learning model to the network entity. Such machine learning-based inference error information feedback may allow the network entity to promptly update and redeploy the machine learning model, while maintaining the ability to refine the machine learning model after an initial deployment.

Aspects of the disclosure are initially described in the context of wireless communications systems. Aspects of the disclosure are then described in the context of a system and a process flow. Aspects of the disclosure are further illustrated by and described with reference to apparatus diagrams, system diagrams, and flowcharts that relate to inference error information feedback for machine learning-based inferences.

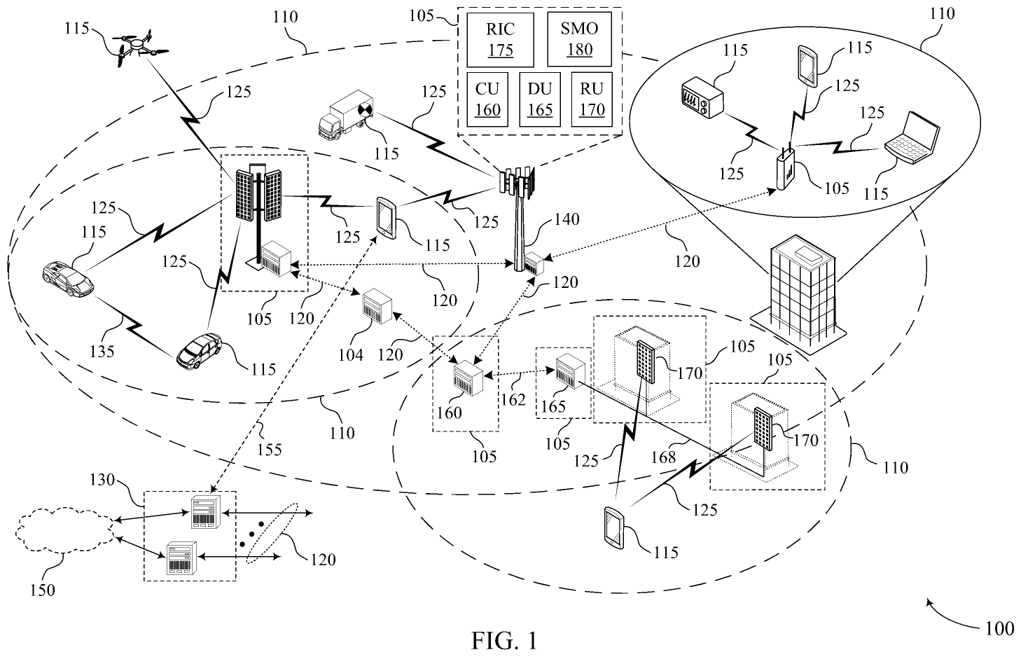

FIG. 1 illustrates an example of a wireless communications system 100 that supports inference error information feedback for machine learning-based inferences in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support inference error information feedback for machine learning-based inferences as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, or a personal computer, a netbook, a smartbook, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some cases, portions of the wireless communication system 100 may implement a machine learning model to predict conditions of a channel or beam for predictive beam management between the UE 115 and the network entity 105. Implementation of the machine learning model may include collection data related to the channel or beam, model training using the collected data, and using the model at the network entity 105 or the UE 115 to infer a channel or beam characteristic that can be used for predictive beam management between the UE 115 and the network entity 105. In some cases, data collection may provide input data for model training and model inference functions. In some cases, algorithm-specific data preparation (e.g., data pre-processing and cleaning, formatting, and transformation) may not be carried out in during data collection. In some cases, training data may be used as an input for the model training function, and inference data may be used as an input for the model inference function.

Model training may include validation and testing which may generate model performance metrics as part of the model testing procedure. In some cases, model training may also include data preparation (e.g., data pre-processing and cleaning, formatting, and transformation), which may be based on training data from data collection. In some cases, model deployment or updating may be used to initially deploy a trained, validated, and tested model or an updated model to the model inference function.

Model inference may provide a model inference output (e.g., predictions or decisions). In some cases, model inference may provide model performance feedback to the model training function. In some cases, the model inference function may also prepare data based on inference data from data collection. In some cases, the model inference function may produce an inference output, where details of the inference output may be use case specific. In some cases, if information derived from the model inference function is suitable for refinement of the model in model training, the model refinement function may provide model performance feedback. The model may also include an actor, which may be a function that receives the output from the model inference function and may trigger or perform a corresponding action by itself or other entities.

A machine learning model may be implemented to infer portions of channel state information (CSI) reported by the UE 115, which may reduce channel state measurement overhead, enhance the breadth or quality of the CSI feedback, or improve an accuracy of or prediction associated with the CSI feedback. The machine learning model may also be implemented for beam management, such as beam prediction in the time or spatial domains for overhead and latency reduction, or beam selection accuracy improvement. The machine learning model may also be implemented for positioning accuracy enhancements for different scenarios.

However, in some cases, collected data may not accurately train the machine learning model to account for some outlier conditions (e.g., corner cases), and collecting data for outlier cases may not be efficient. For these outlier conditions, the difference between the machine learning model predicted value and the actual value may be unacceptably high. In such cases, the machine learning model may fail.

To further train a machine learning model at the network, a network entity 105 may configure a UE 115 to perform inferences (i.e., predictions) for one or more, resource, channel, or beam characteristics using the machine learning model, then compare the inferences to actual measurements of the resource, channel, or beam characteristics to identify and report errors in the machine learning model to the network entity 105 (e.g., in addition to traditional beam management).

For example, the network entity 105 may create the machine learning model (e.g., based on common cases or conditions) and deploy the machine learning model to the UE 115, then configure the UE 115 to report machine learning-based inference errors, such as errors that arise for less-common cases or outlier conditions. The UE 115 may perform inferences for an indicated characteristic using the machine learning model in the spatial domain, time domain, or frequency domain. The UE 115 also may perform an actual measurement of the characteristic and may determine the error between the machine learning model predicted inference and the actual measurement. The UE 115 may report the inference errors to the network entity 105 to update the machine learning model. In some cases, the UE 115 may report the inference error based on a trigger, such as if the inference error satisfies (e.g., exceeds) a threshold value. In some cases, the UE 115 may report its capability regarding performing inference for a machine learning model. Such machine learning-based inference error information feedback may allow the network entity to promptly implement (e.g., deploy) the machine learning model, while maintaining the ability to refine the machine learning model after implementation to address the identified inference errors.

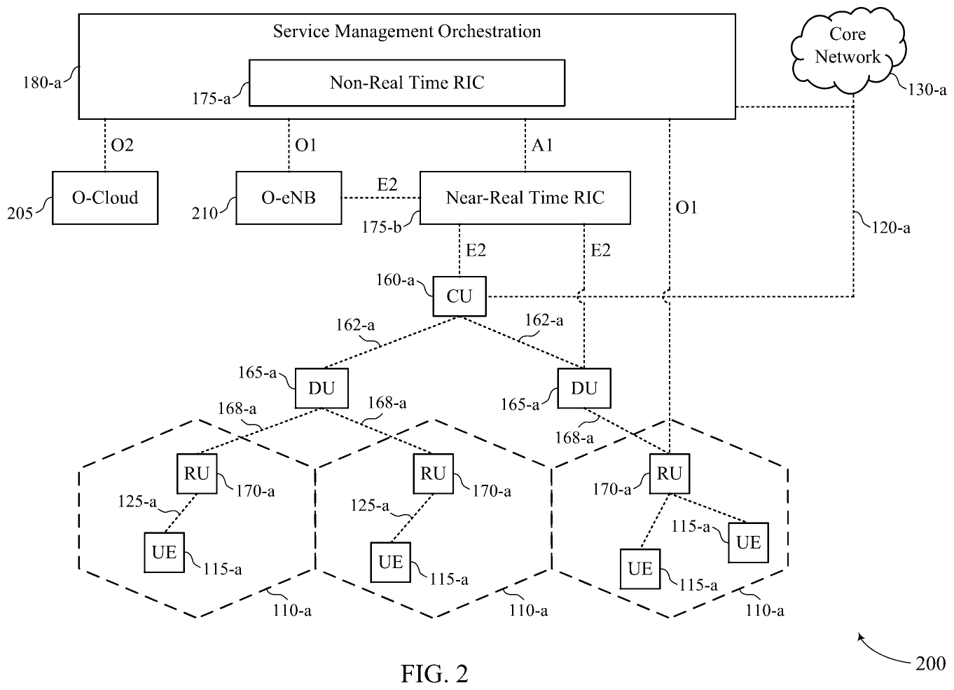

FIG. 2 illustrates an example of a network architecture 200 that (e.g., a disaggregated base station architecture, a disaggregated RAN architecture) that supports inference error information feedback for machine learning-based inferences in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

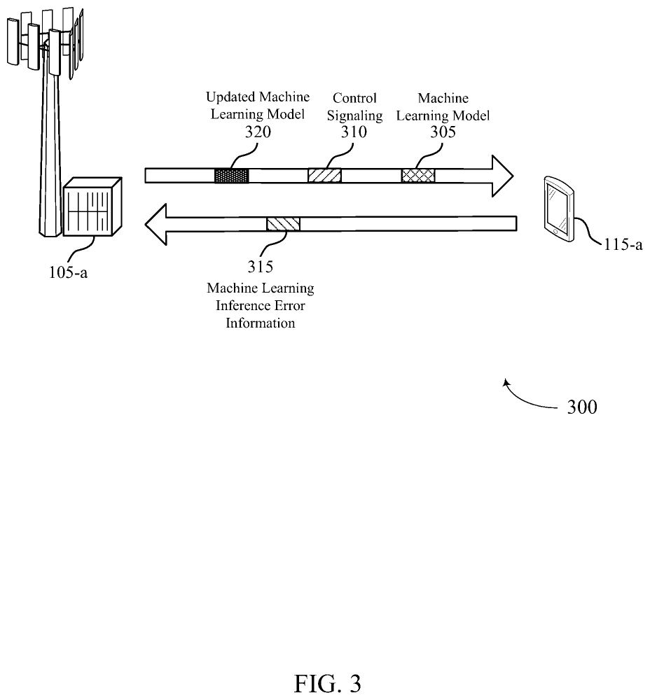

FIG. 3 illustrates an example of a system 300 that supports inference error information feedback for machine learning-based inferences in accordance with one or more aspects of the present disclosure. The system may include a network entity 105-a and a UE 115-a, which may be examples of network entity 105 and UE 115 as described with reference to FIGS. 1 and 2.

The network entity 105-a may develop a machine learning model for predictive beam management. For example, the network entity 105-a may implement a training scheme (e.g., for time domain, spatial domain, or frequency domain) to collect data, train the machine learning model based on the data, and implement (e.g., deploy) the model to, for example, predict or plan a change in a resource, a communication beam, or a communication channel between the UE 115-a and the network entity 105-a. In some cases, the initial set of collected training data may not accurately train the machine learning model for all cases such that the machine learning model may not account for certain outlier conditions. However, the UE 115-a may perform machine learning-based inferences to help the network entity 105-a refine the machine learning model after it has been implemented.

The network entity 105-a may transmit the machine learning model 305 to the UE 115-a. The network entity 105-a also may transmit control signaling 310 indicating a configuration for the UE 115-a to perform a machine learning-based inference for a characteristic of at least one resource, at least one communication beam, or at least one communication channel. The UE 115-a may also obtain a measurement of the characteristic, such as an actual measurement which the UE 115-a may compare to the inference. In some cases, the UE 115-a may determine there is a difference between the machine-learning based inference and the measurement, which may indicate an error with the machine learning model because the machine learning model did not accurately predict the characteristic. The UE 115-a may transmit machine learning inference error information 315 to the network entity 105-a, which may include an indication of the difference between the machine learning-based inference and the characteristic. In some cases, based on the machine learning inference error information 315, the network entity 105-a may update the machine learning model to account for the error detected by the UE 115-a and the network entity 105-a may transmit the updated machine learning model 320 to the UE 115-a. Thus, the machine learning model 305 may be refined after implementation.

Through control signaling 310, the network entity 105-a may configure the UE 115-a to perform a machine learning-based inference (e.g., a prediction) for a resource, a beam, or a channel characteristic in a time domain, spatial domain, or frequency domain. The network entity 105-a may also configure the UE 115-a to actually measure, and optionally report, the resource, beam, or channel characteristic in the time domain, spatial domain, or frequency domain associated with the predicted one. The UE 115-a may determine inference errors because the predicted characteristic is not consistent with the determined characteristic based on the actual measurement. In some cases, the network entity 105-a may request that the UE 115-a transmit machine learning inference error information 315, while in some cases, the UE 115-a may be triggered to transmit the machine learning inference error information 315.

In some cases, the characteristic may be associated with a virtual resource, or a resource that is not transmitted by the network entity 105-a. A virtual resource may be any resource that is not transmitted by the network entity 105-a, and thus does not occupy a resource element (e.g., in the time domain or frequency domain). A virtual resource may be a prediction resource or prediction resource set configured by the network entity 105-a. In such cases, the UE 115-a may use an association between SSBs and CSI-RSs to obtain a measurement of the characteristic for comparison with the machine learning-based inference or predicted characteristic. For example, the association between SSB and CSI-RS may be used for beam pointing directions, beam widths, beamforming gains, beam pointing direction neighboring information, or linear-combination based associations (e.g., a linear-combination of SSBs and CSI-RSs). In some cases, associations between SSB and CSI-RS may be configured by the network entity 105-a and transmitted to the UE 115-a in control signaling 310. When the characteristic is associated with a virtual resource (e.g., a non-transmitted resource), the UE 115-a may obtain a measurement corresponding to an SSB, and predict beams that were supposed to be measured via CSI-RS, but were not actually transmitted.

The machine learning inference error information 315 may include an indication of a difference between the machine learning-based inference and the measurement of the characteristic, which may include information associated with one or multiple inference errors, for at least one resource, at least one communication beam, or at least one communication channel. In some cases, the machine learning inference error information 315 may include the inference of the characteristic based on machine learning model inputs, the actual measurement of the characteristic, or both with respect to instances where inference errors occurred. In some cases, the machine learning inference error information 315 may include hidden layer states associated with the predicted characteristic with respect to the instances where the inference errors occurred.

The predicted characteristic results based on the machine learning-based inference may be a first set of identifiers (e.g., channel state information reference signal (CSI-RS) or a synchronization symbol block (SSB) identifiers) corresponding to one or more resources with a highest predicted measurement of the characteristic. For example, the first set of identifiers may be what the UE 115-a predicts to be the strongest resources according to reference signal received power (RSRP) or signal to interference and noise ratio (SINR) (e.g., the greatest Layer 1 RSRP (L1-RSRP) or the greatest Layer 1 SINR (L1-SINR)). In some cases, the UE 115-a may order the identifiers according to their predicted RSRP or SINR strengths. In some cases, the identifiers may not be ordered but the top resource identifiers may be grouped together (e.g., the top ten resources). In some cases, the first set of identifiers may be the output, or result, of the machine learning-based model. In some cases, the output of the machine learning-based model may be the RSRP or SINR values of each resource, and the UE 115-a may identify the resource identifiers based on the predicted RSRP or SINR values.

The UE 115-a may perform a measurement with respect to one or more real or virtual resources to determine a second set of identifiers corresponding to one or more resources having a highest actual predicted measurement of the characteristic (e.g., based on measured RSRP or SINR). The machine learning inference error information 315 may include the first set of identifiers, the second set of identifiers, an indication of a difference between the first set of identifiers and the second set of identifiers, or any combination thereof. For example, the UE 115-a may report, via resource identifiers, how many resources within the predicted top resources are within the measured top resources, or how many resources within the measured top resources are within the predicted top resources. In some cases, the UE may include which resources were included in both the predicted and measured top resources, and which resources were not. In an example, the UE 115-a may predict the five top resources to be A, B, C, D, and E. However, the UE 115-a may measure the actual top resources to be A, C, D, F, and G. In the machine learning inference error information 315, the UE 115-a may indicate the identifiers associated with the predicted resources A, B, C, D, and E, the measured resources A, C, D, F, and G, that B and E were predicted to be top resources but were not, that F and G were not predicted to be top resources but were measured as top resources, or any combination thereof.

In some cases, the UE 115-a may perform the machine learning-based inference for a resource, beam, or channel characteristic associated with the time domain. For example, for the machine learning-based inference, the UE 115-a may apply the machine learning model to one or more historic values of the characteristic, such as a historically measured or predicted characteristic, to predict one or more later values of the characteristic. The predicted later value of the characteristic may be the machine learning-based inference, such as an output of the machine learning model predicting the later (e.g., future) value. In some cases, the historic value of the characteristic may be associated with a resource set (e.g., a CSI-RS or an SSB resource set), and the later value of the characteristic may be associated one or more resources (e.g., CSI-RS or SSB) within the resource set.

In some cases, in the time domain, the one or more historic values or the machine learning model inputs, may be a time series of a number of historic values of the characteristic. In some cases, the UE 115-a may receive an indication of a length of time series of the number of historic values of the characteristic (e.g., in the control signaling 310).

The UE 115-a may perform a measurement of the characteristic with respect to one or more real or virtual resources in the time domain for comparison with the predicted characteristic. In some cases, when the UE 115-a performs a measurement of the characteristic with respect to one or more virtual resources, the virtual resources may not be transmitted by the network entity 105-a, and the UE 115-a may perform a measurement of the characteristic using a prediction resource or a prediction resource set in the time domain.

In some cases, the characteristic may include a signal strength associated with the resource, communication channel, or communication beam. For example, the historic value may be a time series of one or more resource identifiers (e.g., CSI-RS or SSB resource identifiers), and potentially their orders, associated with the strongest signal among the resources within the resource set. In some cases, the characteristic may be a change in signal strength associated with the resource, communication channel, or beam. For example, the historic value may be a time series of whether the resource identifier associated with the strongest signal changed compared to a previous measurement instance. In some cases, the characteristic may be an explicit channel characteristic associated with the resource, communication channel or beam. For example, the historic value may be a time series of explicit signal values associated with one or more resource identifiers within the resource set, or the historic value may be a time series of an explicit channel characteristic estimated based on the resources within the resource set. In some cases, the characteristic may be a location of the UE 115-a during communication over the resource, communication beam, or channel (e.g., a time series of the UE 115-a's location information). In some cases, the characteristic may be a set of one or more receive beams used to communicate over the resource, communication beam, or channel. For example, the historic value may be a time series of the UE 115-a's receive beam information associated with the measured resources. In some cases, the characteristic may be a combination of one or more characteristics.

In some cases, the control signaling 310 may configure the UE 115-a to include in the machine learning inference error information 315 both the historic value of the characteristic and the predicted later value of the characteristic. For example, in the control signaling 310, the UE 115-a may receive an instruction to report the historic value of the characteristic and the predicted later value of the characteristic. In some cases, the machine learning inference error information 315 may also include the length of time series of the number of historic values of the characteristic, an indication of a length of time series of the number of historic values of the characteristic, or any combination thereof. In some cases, the UE 115-a may compress the time series of inferences and measured values, which the network entity 105-a may decompress upon receiving the inference error information 315.

In some cases, the UE 115-a may perform the machine learning-based inference for a resource, beam, or channel characteristic associated with the spatial domain, where the characteristic may be defined with respect to a set of one or more reference signal resources, such as a set of one or more channel state information reference signal (CSI-RS)) resources, a set of one or more synchronization signal block (SSB) resource sets, or combinations thereof. For example, the UE 115-a may apply the machine learning model to a first value of a characteristic associated with a first set of one or more resource identifiers to predict at least one second value of the characteristic associated with a second set of one or more resource identifiers, where the first set of resource identifiers may be spatially different than the second set. For example, the machine learning model input may be a characteristic associated with a number of resources (e.g., CSI-RS or SSB resources) within a resource set, and the machine learning model output (e.g., the inference of the characteristic) may be a predicted characteristic associated with non-measured resources within the resource set.

In the spatial domain, the characteristic may include a signal strength associated with the resource, communication channel, or communication beam, a change in signal strength associated with the resource, communication channel, or beam, an explicit channel characteristic (or its compressed representations) associated with the resource, communication channel, or beam, an angular characteristic associated with the resource, communication beam, or channel, a location of the UE 115-a during communication over the resource, communication beam, or channel, a set of one or more receive beams used to communicate over the resource, communication beam, or channel, or any combination thereof.

In some cases, the control signaling 310 may configure the UE 115-a to include in the machine learning inference error information 315 both the first value of the characteristic associated with the first set of one or more resource identifiers and at least one second value of the characteristic associated with the second set of resource identifiers. For example, in the control signaling 310, the UE 115-a may receive an instruction to report the predicted characteristic with respect to the first set of resources within a resource set based on the measurement of a second set of real or virtual resources within the same resource set and the actual measured characteristic associated with the second set of resources. In some cases, the second set of resources may include one or more virtual resources which may be a part of a set of prediction resources which the UE 115-a may use when the characteristic is associated with a virtual or non-transmitted resource.

In some cases, the UE 115-a may perform the machine learning-based inference for a resource, beam, or channel characteristic associated with the frequency domain, where the characteristic may be defined with respect to a set of one or more reference signal resources, such as a set of one or more channel state information reference signal (CSI-RS)) resources, a set of one or more synchronization signal block (SSB) resource sets, or combinations thereof. For example, the UE 115-a may apply the machine learning model to a first value of a characteristic associated with a first set of one or more resource identifiers to predict at least one second value of the characteristic associated with a second set of one or more resource identifiers, where the first and second sets of resource identifiers may be associated with different bandwidth parts or serving cells. For example, the machine learning model input may include measured characteristics associated with a first resource set (e.g., a CSI-RS or an SSB resource set) associated with a first bandwidth part or a first serving cell, and the machine learning model output or the machine learning-based inference may include characteristics associated with a non-measured second resource set associated with a second bandwidth part or a second serving cell.

The UE 115-a may perform a measurement of the characteristic with respect to one or more real or virtual resources in the frequency domain for comparison with the predicted characteristic. In some cases, when the UE 115-a performs a measurement of the characteristic with respect to one or more virtual resources, the virtual resources may not be transmitted by the network entity 105-a, and the UE 115-a may perform a measurement of the characteristic using a prediction resource or a prediction resource set in the time domain.

In the frequency domain, the characteristic may include a signal strength associated with the resource, communication channel, or communication beam, a change in signal strength associated with the resource, communication channel, or beam, an explicit channel characteristic (or its compressed representations) associated with the resource, communication channel, or beam, an angular characteristic associated with the resource, communication beam, or channel, a location of the UE 115-a during communication over the resource, communication beam, or channel, a set of one or more receive beams used to communicate over the resource, communication beam, or channel, a bandwidth part identifier associated with communicating over the resource, communication beam, or channel, a serving cell identifier associated with communicating over the resource, communication beam, or channel, a central frequency associated with communicating over the resource, communication beam, or channel, a numerology associated with communicating over the resource, communication beam, or channel, or any combination thereof.

In some cases, the control signaling 310 may configure the UE 115-a to include in the machine learning inference error information 315 both the first value of the characteristic associated with the first set of one or more resource identifiers and at least one second value of the characteristic associated with the second set of resource identifiers. For example, in the control signaling 310, the UE 115-a may receive an instruction to report the predicted characteristic with respect to a resource set associated with a first bandwidth part of serving cell based on the machine learning model and the characteristic associated with the resource set based on the actual measurement.

In some cases, for network entity 105-a requested machine learning inference error information 315, after determining an inference error associated with a certain instance, the network entity 105-a may request the UE 115-a to further report machine learning inference error information 315. In some cases, the UE 115-a may proactively report machine learning inference error information 315. For example, the UE 115-a may use the machine learning model to trigger decisions, but the UE 115-a may not directly report the predicted inferences. In some cases, the UE 115-a may perform an actual measurement of a characteristic with respect to one or more real or virtual resources in the spatial domain, the time domain, the frequency domain, or any combination thereof, and determine that the machine learning-based inference associated with the characteristic is not consistent with the measurement. The UE 115-a may determine there is an inference error and may proactively report the machine learning inference error information to the network entity 105-a. In some cases, the UE 115-a may not include all inferences, only those the UE 115-a determines are relevant to important error information. In some cases, the UE 115-a may request to report the information to the network entity 105-a.

In some cases, the UE 115-a may transmit the machine learning inference error information 315, which may include an indication of the difference between the machine learning-based inference and the measurement of the characteristic, via an application layer protocol (e.g., CSI-RS resource or report setting identifiers or slot or subframe identifiers may be included), a radio resource control (RRC) layer (e.g., based on UE 115-a requests), or a medium access (MAC) control layer (e.g., based on UE 115-a requests). In some cases, the indication of the difference may include physical layer information associated with the machine learning-based inference.

In some cases, the UE 115-a may transmit the machine learning inference error information 315 in a channel state information (CSI) report via a physical layer uplink control information transmission. For example, the UE 115-a may receive a request from the network entity 105-a via downlink control information (DCI), MAC control element (MAC-CE), or RRC signaling. The UE 115-a may transmit the machine learning inference error information 315 jointly with regular CSI payloads in the same CSI report (e.g., with indications to tell whether inference error information is compromised), or the UE 115—may separately request additional CSI or uplink control information (UCI) transmissions. In some cases, the priority of the machine learning inference error information 315 may be lower than the priority of other CSI.

In some cases, the UE 115-a may also transmit an indication of a state of one or more hidden layers of the machine learning model associated with the machine learning-based inference (e.g., in the machine learning inference error information 315).

In a time domain example, the UE 115-a may be configured to report signal strength through a periodic CSI report associated with the strongest SSB resources of an SSB resource set with a certain periodicity. The UE may run the machine learning model 305 to determine predicted signal strength associated with the SSB resources while measuring an actual signal strength associated with the predicted signal strengths based on a measurement of the SSB resources or virtual resources which may be used as prediction resources when the SSB resources are not-transmitted by the network entity 105-a. In some cases, the UE 115-a may jointly report the signal strength and the machine learning inference error information 315. For example, in the periodic CSI report, a dedicated bit or predefined signal strength codepoints associated with a number of reported signal strengths may be used to indicate whether the reported payload is for reporting signal strength or for jointly reporting signal strength and machine learning inference error information 315. If the UE 115-a indicates joint reporting, the network entity 105-a may re-interpret the report by reducing the number of reported signal strengths (e.g., on the strongest SSB is reported), reducing the signal strength reporting step-size or quantization granularity while the machine learning inference error information 315 is also reported with the payload, or any combination thereof. In some cases, the UE 115-a may report the signal strength and the machine learning inference error information 315 separately. For example, the UE may proactively request to transmit the machine learning inference error information 315 via an additional CSI report, where the request may be based on a dedicated SR resource, dedicated payloads in the P-CSI report, or any other UCI payloads.

In some cases, the UE 115-a may transmit machine learning inference error information 315 in accordance with a triggering condition. In some cases, the UE 115-a may receive an indication of the triggering condition. In some cases, the triggering condition may be when the difference between the machine learning-based inference and the measurement of the characteristic (e.g., the inference error) satisfies (e.g., exceeds) a threshold. In some cases, the threshold by be configured through control signaling 310, or the threshold may be predefined. For example, when the UE determines that an inference error is above the configured threshold, it could trigger machine learning inference error information 315 to be sent. For example, the threshold may be 15 dBm, such that a difference between a predicted signal strength and the measured signal strength is greater than 15 dBm, the UE 115-a may proactively report the machine learning inference error information 315.

In some cases, UE 115-a may be a specific class of UE 115, such as a UE 115 that is capable of helping the network improve machine learning model performance. In some cases, the UE 115-a may transmit a capability report indicating a capability to perform the machine learning-based inference, a capability to perform an actual measurement of the characteristic, a capability to transmit machine learning inference error information, or any combination thereof.

Based on the inference and the actual measurement, the UE 115-a may transmit machine learning inference error information 315. The UE 115-a may transmit machine learning inference error information 315 in accordance with a triggering condition. In some cases, the UE 115-a may receive an indication of the triggering condition. In some cases, the triggering condition may be when the difference between the machine learning-based inference and the measurement of the characteristic (e.g., the inference error) satisfies (e.g., exceeds) a threshold. In some cases, the threshold by be configured through control signaling 310, or the threshold may be predefined.

Based on the reported errors or differences, the network entity 105-a may refine the machine learning model and may transmit an updated machine learning model 320 to the UE 115-a. Additionally, or alternatively, the network entity 105-a may use the refined machine learning model at the network entity 105-a to infer or predict characteristics of communication beams or channels for use in predictive beam management. Additionally, or alternatively, the network entity 105-a may deploy the refined machine learning model to another device, such as a second UE (not shown), for use at that device.

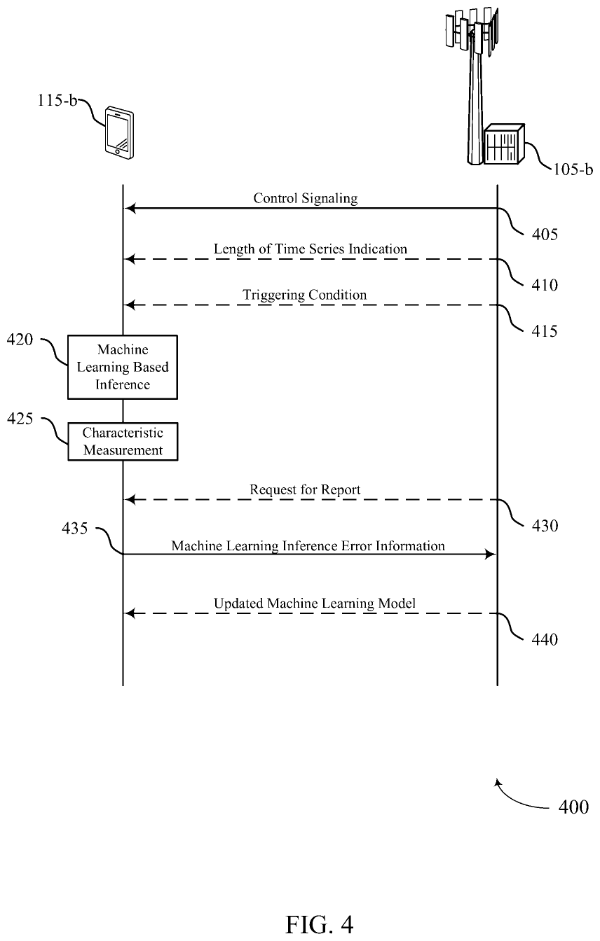

FIG. 4 illustrates an example of a process flow 400 that supports inference error information feedback for machine learning-based inferences in accordance with one or more aspects of the present disclosure. The process flow 400 may implement various aspects of the present disclosure described with reference to FIGS. 1-3. The process flow 400 may include network entity 105-b and UE 115-b, which may be examples of the network entities 105 and the UEs 115 described with reference to FIGS. 1-3.

In the following description of the process flow 400, the operations described may be performed in different orders or at different times. Some operations may also be left out of the process flow 400, or other operations may be added. Although the network entity 105-b and the UE 115-b are shown performing the operations of the process flow 400, some aspects of some operations may also be performed by other elements of the process flow 400 or by elements that are not depicted in the process flow 400, or any combination thereof.

At 405, the network entity 105-b may transmit, and UE 115-b may receive, control signaling. The control signaling may be the control signaling 310 as described with reference to FIG. 3. The control signaling may indicate a configuration for the UE to perform a machine learning-based inference for a characteristic of at least one resource, at least one communication beam, or at least one communication channel, where the characteristic may be associated with one or more of a spatial domain, a time domain, or a frequency domain, as described with reference to FIG. 3.

In some cases, at 410, the network entity 105-b may transmit, and the UE 115-b may receive, a length of time series indication, as described with reference to FIG. 3. For example, if the characteristic is associated with the time domain, the UE 115-a may use the length of time series indication to perform the machine learning-based inference for a number of historic values of the characteristic included in the length of time series. In some cases, the length of time series indication may be included in the control signaling at 405.

In some cases, at 415, the network entity 105-b may transmit, and the UE 115-a may receive, the triggering condition as described with reference to FIG. 3. For example, the triggering condition may indicate when the UE 115-b is to transmit an indication of a difference between the machine learning-based inference and the measurement of the characteristic (e.g., the machine learning inference error information 315 as described with reference to FIG. 3). In some cases, as described with reference to FIG. 3, the triggering condition may occur when the difference between the machine learning-based inference and the measurement of the characteristic satisfies (e.g., exceeds) a threshold.

At 420, the UE 115-b may perform the machine learning-based inference as described with reference to FIG. 3. For example, the UE 115-b may perform the learning-based inference for the characteristic of the at least one resource, the at least one communication beam, or the at least one communication channel in accordance with the configuration (e.g., the configuration indicated in the control signaling at 405).

At 425, the UE 115-b may perform a characteristic measurement, as described with reference to FIG. 3. For example, the UE 115-b may perform a measurement of the characteristic of the at least one resource, the at least one communication beam, or the at least one communication channel. The measurement of the characteristic may be an actual value associated with the inferred (e.g., predicted) characteristic. In some cases, as described with reference to FIG. 3, the UE 115-b may perform the characteristic measurement using a virtual resource.

In some cases, at 430, the network entity 105-b may transmit, and the UE 115-b may receive, a request for a report, as described with reference to FIG. 3. For example, the request may be for UE 115-b to transmit machine learning inference error information 315, as described with reference to FIG. 3. In some cases, the request for a report may also include an instruction to report the at least one historic value of the characteristic and the predicted at least one later value of the characteristic. In some cases, the request for a report may also include an instruction to report the at least one first value of the characteristic associated with the first set of one or more reference signal resource identifiers or SSB resource identifiers and the at least one second value of the characteristic associated with the second set of one or more reference signal resource identifiers or SSB resource identifiers.

At 435, the UE 115-b may transmit, and the network entity 105-b may receive, machine learning inference error information as described with reference to FIG. 3. In some cases, the UE 115-b may transmit machine learning inference error information in accordance with the triggering condition. The machine learning inference error information may include an indication of a difference between the machine learning-based inference and the measurement of the characteristic for the at least one resource, the at least one communication beam, or the at least one communication channel. For example, the machine learning inference error information may indicate to the network entity 105-b that there is an error associated with the machine learning model, which may help the network entity 105-b update (e.g., refine) the machine learning model after implementation. As described with reference to FIG. 3, the UE 115-b may transmit a first set of resource identifiers predicted to be the strongest resources, a second set of resource identifiers actually measured to be the strongest resources, or any combination thereof.

In some cases, at 440, the network entity 105-b may transmit, and the UE 115-b may receive, an updated machine learning model. For example, the machine learning model may now be updated to account for the characteristic that resulted in an error with the original machine learning model.

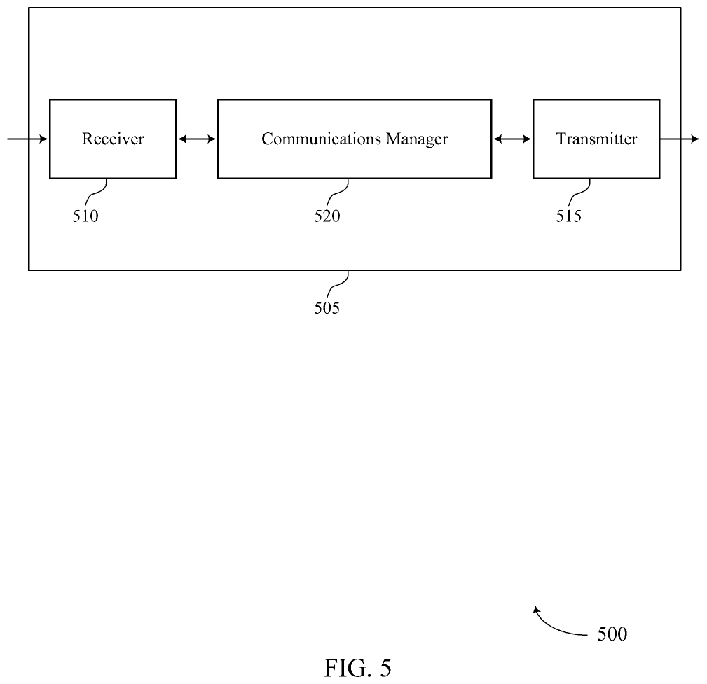

FIG. 5 shows a block diagram 500 of a device 505 that supports inference error information feedback for machine learning-based inferences in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to inference error information feedback for machine learning-based inferences). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inference error information feedback for machine learning-based inferences). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of inference error information feedback for machine learning-based inferences as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU) an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The communications manager 520 may be configured as or otherwise support a means for performing the machine learning-based inference for the characteristic of the at least one resource, the at least one communication beam, or the at least one communication channel in accordance with the configuration. The communications manager 520 may be configured as or otherwise support a means for performing a measurement of the characteristic of the at least one resource, the at least one communication beam, or the at least one communication channel. The communications manager 520 may be configured as or otherwise support a means for transmitting, in accordance with a triggering condition, an indication of a difference between the machine learning-based inference and the measurement of the characteristic for the at least one resource, the at least one communication beam, or the at least one communication channel.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for enhanced beamforming and communication reliability.

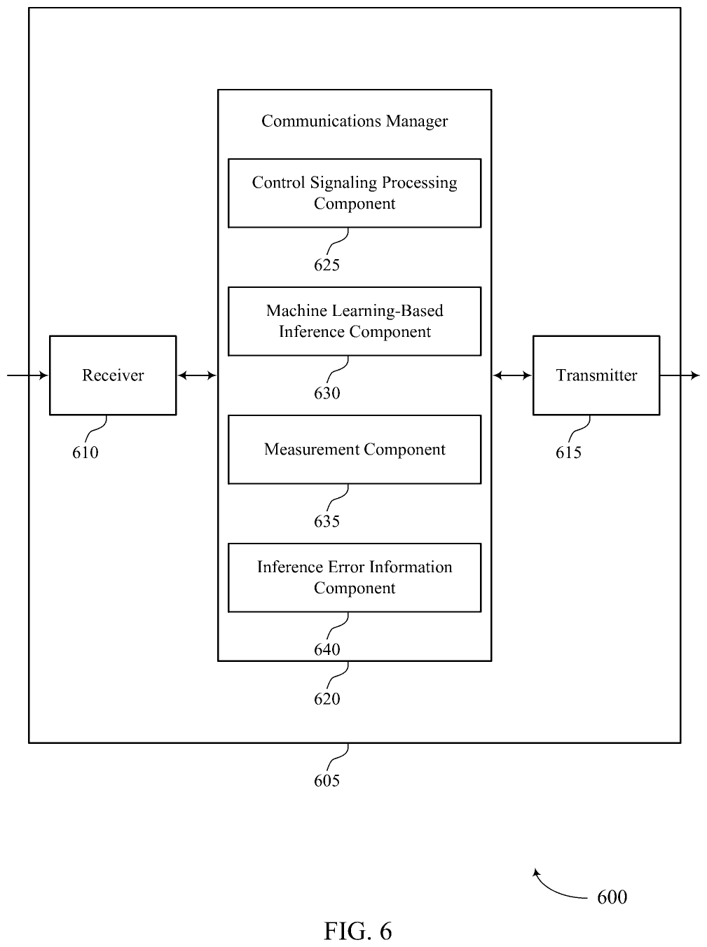

FIG. 6 shows a block diagram 600 of a device 605 that supports inference error information feedback for machine learning-based inferences in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inference error information feedback for machine learning-based inferences). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inference error information feedback for machine learning-based inferences). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of inference error information feedback for machine learning-based inferences as described herein. For example, the communications manager 620 may include a control signaling processing component 625, a machine learning-based inference component 630, a measurement component 635, an inference error information component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The control signaling processing component 625 may be configured as or otherwise support a means for receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The machine learning-based inference component 630 may be configured as or otherwise support a means for performing the machine learning-based inference for the characteristic of the at least one resource, the at least one communication beam, or the at least one communication channel in accordance with the configuration. The measurement component 635 may be configured as or otherwise support a means for performing a measurement of the characteristic of the at least one resource, the at least one communication beam, or the at least one communication channel. The inference error information component 640 may be configured as or otherwise support a means for transmitting, in accordance with a triggering condition, an indication of a difference between the machine learning-based inference and the measurement of the characteristic for the at least one resource, the at least one communication beam, or the at least one communication channel.

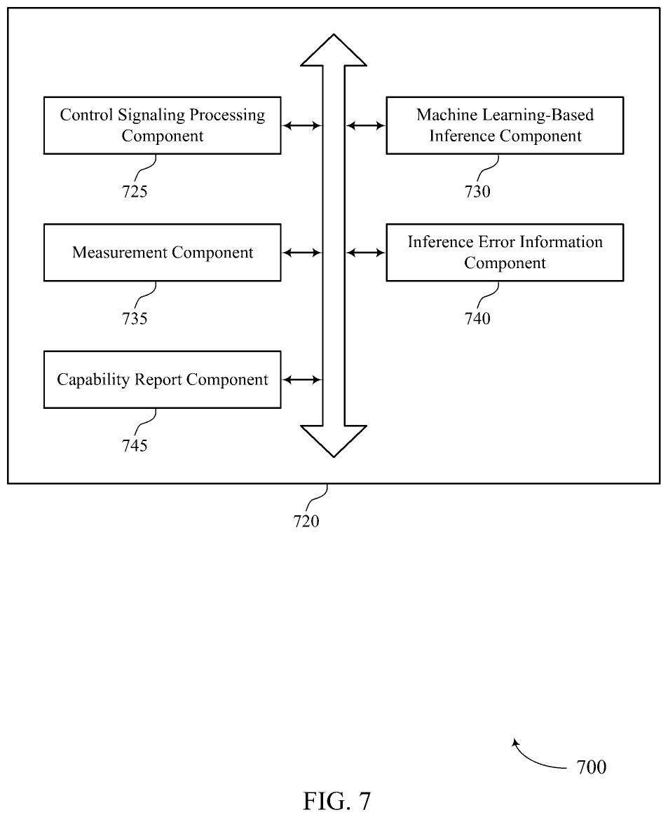

FIG. 7 shows a block diagram 700 of a communications manager 720 that supports inference error information feedback for machine learning-based inferences in accordance with one or more aspects of the present disclosure. The communications manager 720 may be an example of aspects of a communications manager 520, a communications manager 620, or both, as described herein. The communications manager 720, or various components thereof, may be an example of means for performing various aspects of inference error information feedback for machine learning-based inferences as described herein. For example, the communications manager 720 may include a control signaling processing component 725, a machine learning-based inference component 730, a measurement component 735, an inference error information component 740, a capability report component 745, or any combination thereof. Each of these components may communicate, directly or indirectly, with one another (e.g., via one or more buses).

The communications manager 720 may support wireless communication at a UE in accordance with examples as disclosed herein. The control signaling processing component 725 may be configured as or otherwise support a means for receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The machine learning-based inference component 730 may be configured as or otherwise support a means for performing the machine learning-based inference for the characteristic of the at least one resource, the at least one communication beam, or the at least one communication channel in accordance with the configuration. The measurement component 735 may be configured as or otherwise support a means for obtaining a measurement of the characteristic of the at least one resource, the at least one communication beam, or the at least one communication channel. The inference error information component 740 may be configured as or otherwise support a means for transmitting, in accordance with a triggering condition, an indication of a difference between the machine learning-based inference and the measurement of the characteristic for the at least one resource, the at least one communication beam, or the at least one communication channel.

In some examples, to support performing the machine learning-based inference for the characteristic and obtaining the measurement of the characteristic, the machine learning-based inference component 730 may be configured as or otherwise support a means for identifying, based at least in part on the machine learning-based inference, a first set of identifiers corresponding to one or more resources having a highest predicted measurement of the characteristic of the at least one resource, the at least one communication beam, or the at least one communication channel, and identifying, based at least in part on obtaining the measurement of the characteristic, a second set of identifiers corresponding to one or more resources having a highest actual predicted measurement of the characteristic of the at least one resource, the at least one communication beam, or the at least one communication channel.

In some examples, to support transmitting the indication of a difference between the machine learning-based inference and the measurement of the characteristic, the inference error information component 740 may transmit one or more of: the first set of identifiers, the second set of identifiers, an indication of a difference between the first set of identifiers and the second set of identifiers, or any combination thereof.

In some examples, to support obtaining the measurement of the characteristic, the measurement component 735 may obtain a virtual measurement of a virtual resource associated with the characteristic of the at least one resource, the at least one communication beam, or the at least one communication channel, wherein the virtual resource is a non-transmitted resource.

In some examples, to support performing the machine learning-based inference for the characteristic of the at least one resource, the at least one communication beam, or the at least one communication channel, the machine learning-based inference component 730 may be configured as or otherwise support a means for applying a machine learning model to at least one historic value of the characteristic to predict at least one later value of the characteristic, where the machine learning-based inference includes the predicted at least one later value of the characteristic.

In some examples, to support receiving the control signaling, the control signaling processing component 725 may be configured as or otherwise support a means for receiving an instruction to report the at least one historic value of the characteristic and the predicted at least one later value of the characteristic.

In some examples, to support transmitting the indication of the difference between the machine learning-based inference and the measurement of the characteristic, the inference error information component 740 may be configured as or otherwise support a means for transmitting the at least one historic value of the characteristic and the predicted at least one later value of the characteristic in accordance with the received instruction.

In some examples, the at least one historic value of the characteristic includes a time series of a set of multiple historic values of the characteristic.

In some examples, the control signaling processing component 725 may be configured as or otherwise support a means for receiving an indication of a length of the time series of the set of multiple historic values of the characteristic.

In some examples, to support transmitting the indication of the difference between the machine learning-based inference and the measurement of the characteristic, the inference error information component 740 may be configured as or otherwise support a means for transmitting an indication of a length of the time series of the set of multiple historic values of the characteristic.

In some examples, to support performing the machine learning-based inference for the characteristic of the at least one resource, the at least one communication beam, or the at least one communication channel, the machine learning-based inference component 730 may be configured as or otherwise support a means for applying a machine learning model to at least one first value of the characteristic associated with a first set one or more reference signal resource identifiers or SSB resource identifiers to predict at least one second value of the characteristic associated with a second set of one or more reference signal resource identifiers or SSB resource identifiers, where the machine learning-based inference includes the predicted at least one second value of the characteristic.

In some examples, the first set of one or more reference signal resource identifiers or SSB resource identifiers is spatially different than the second set of one or more reference signal resource identifiers or SSB resource identifiers.

In some examples, the first set of one or more reference signal resource identifiers or SSB resource identifiers and the second set of one or more reference signal resource identifiers or SSB resource identifiers are associated with different bandwidth parts or serving cells.

In some examples, to support receiving the control signaling, the control signaling processing component 725 may be configured as or otherwise support a means for receiving an instruction to report the at least one first value of the characteristic associated with the first set one or more reference signal resource identifiers or SSB resource identifiers and the at least one second value of the characteristic associated with the second set of one or more reference signal resource identifiers or SSB resource identifiers.

In some examples, to support transmitting the indication of the difference between the machine learning-based inference and the measurement of the characteristic, the inference error information component 740 may be configured as or otherwise support a means for transmitting the at least one first value of the characteristic associated with the first set one or more reference signal resource identifiers or SSB resource identifiers and the at least one second value of the characteristic associated with the second set of one or more reference signal resource identifiers or SSB resource identifiers.

In some examples, the control signaling processing component 725 may be configured as or otherwise support a means for receiving an indication of the triggering condition.

In some examples, the triggering condition occurs when the difference between the machine learning-based inference and the measurement of the characteristic satisfies a threshold.

In some examples, the capability report component 745 may be configured as or otherwise support a means for transmitting a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

In some examples, to support wireless communications, the machine learning-based inference component 730 may be configured as or otherwise support a means for a signal strength associated with the at least one communication channel or the at least one communication beam, a change in signal strength associated with the at least one communication channel or the at least one communication beam, an explicit channel characteristic associated with the at least one resource, the at least one communication beam, or the at least one communication channel, an angular characteristic associated with the at least one resource, the at least one communication beam, or the at least one communication channel, a location of the UE during communication over the at least one resource, the at least one communication beam, or the at least one communication channel, a set of one or more UE receive beams used to communicate over the at least one resource, the at least one communication beam, or the at least one communication channel, a bandwidth part identifier associated with communicating over the at least one resource, the at least one communication beam, or the at least one communication channel, a serving cell identifier associated with communicating over the at least one resource, the at least one communication beam, or the at least one communication channel, a central frequency associated with communicating over the at least one resource, the at least one communication beam, or the at least one communication channel, or a numerology associated with communicating over the at least one resource, the at least one communication beam, or the at least one communication channel.

In some examples, the characteristic is defined with respect to a set of one or more reference signal resource sets or one or more SSB resource sets.

In some examples, an application layer protocol, a radio resource control layer, or a medium access control layer, the indication including physical layer information associated with the machine learning-based inference.

In some examples, the indication of the difference between the machine learning-based inference and the measurement of the characteristic is transmitted in a channel state information report via a physical layer uplink control information transmission.

In some examples, to support transmitting the indication of the difference between the machine learning-based inference and the measurement of the characteristic, the inference error information component 740 may be configured as or otherwise support a means for transmitting an indication of a state of one or more hidden layers of a machine learning model associated with the machine learning-based inference.

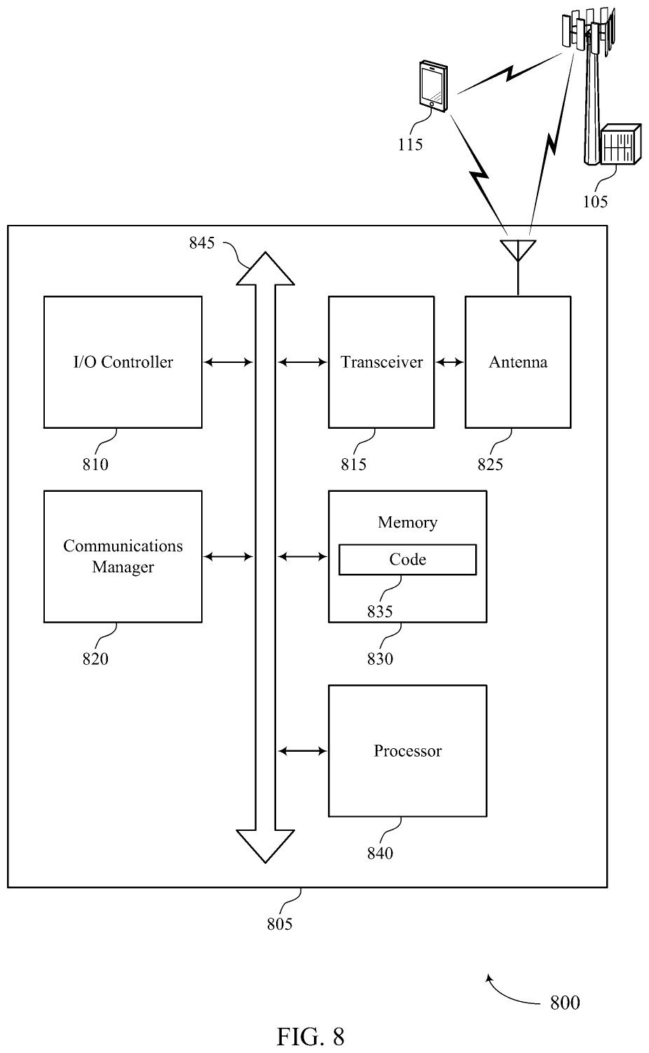

FIG. 8 shows a diagram of a system 800 including a device 805 that supports inference error information feedback for machine learning-based inferences in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting inference error information feedback for machine learning-based inferences). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The communications manager 820 may be configured as or otherwise support a means for performing the machine learning-based inference for the characteristic of the at least one resource, the at least one communication beam, or the at least one communication channel in accordance with the configuration. The communications manager 820 may be configured as or otherwise support a means for performing a measurement of the characteristic of the at least one resource, the at least one communication beam, or the at least one communication channel. The communications manager 820 may be configured as or otherwise support a means for transmitting, in accordance with a triggering condition, an indication of a difference between the machine learning-based inference and the measurement of the characteristic for the at least one resource, the at least one communication beam, or the at least one communication channel.

By including or configuring the communications manager 820 in accordance with examples as described herein, the device 805 may support techniques for improved communication reliability, reduced latency, and improved user experience related to improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of inference error information feedback for machine learning-based inferences as described herein, or the processor 840 and the memory 830 may be otherwise configured to perform or support such operations.

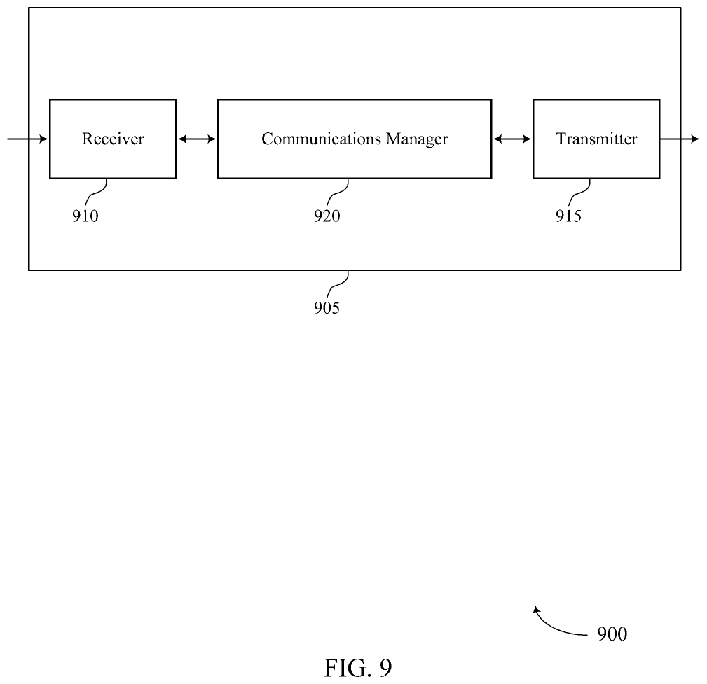

FIG. 9 shows a block diagram 900 of a device 905 that supports inference error information feedback for machine learning-based inferences in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of inference error information feedback for machine learning-based inferences as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting control signaling indicating a configuration for a UE to perform a machine learning-based inference for a characteristic of at least one resource, at least one communication beam, or at least one communication channel. The communications manager 920 may be configured as or otherwise support a means for receiving, in accordance with a triggering condition, an indication of a difference between the machine learning-based inference and a measurement of the characteristic for the at least one resource, the at least one communication beam, or the at least one communication channel at the UE.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

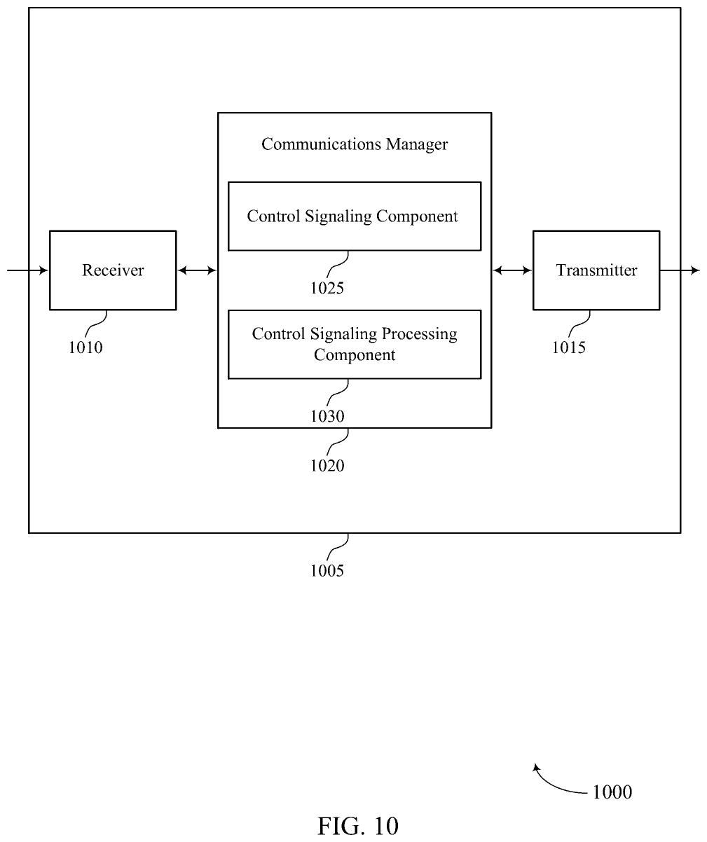

FIG. 10 shows a block diagram 1000 of a device 1005 that supports inference error information feedback for machine learning-based inferences in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of inference error information feedback for machine learning-based inferences as described herein. For example, the communications manager 1020 may include a control signaling component 1025 a control signaling processing component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The control signaling component 1025 may be configured as or otherwise support a means for transmitting control signaling indicating a configuration for a UE to perform a machine learning-based inference for a characteristic of at least one resource, at least one communication beam, or at least one communication channel. The control signaling processing component 1030 may be configured as or otherwise support a means for receiving, in accordance with a triggering condition, an indication of a difference between the machine learning-based inference and a measurement of the characteristic for the at least one resource, the at least one communication beam, or the at least one communication channel at the UE.

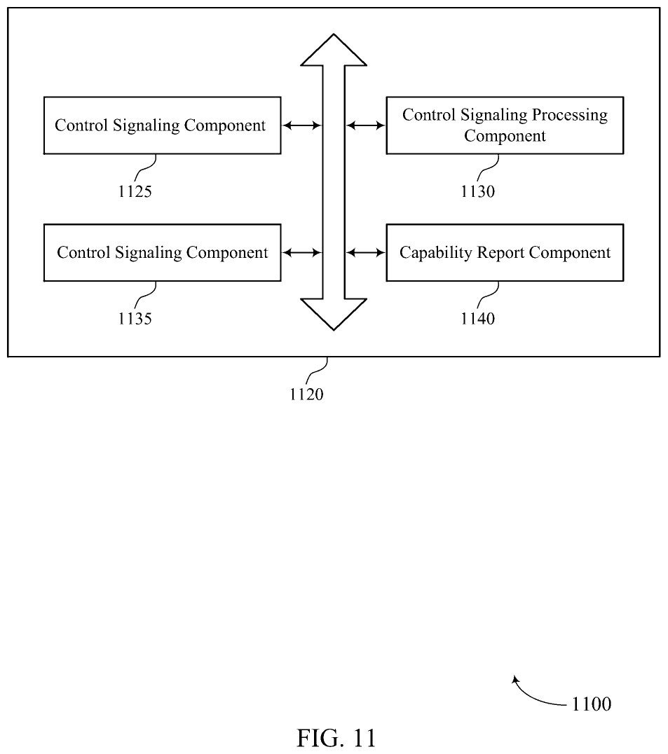

FIG. 11 shows a block diagram 1100 of a communications manager 1120 that supports inference error information feedback for machine learning-based inferences in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of inference error information feedback for machine learning-based inferences as described herein. For example, the communications manager 1120 may include a control signaling component 1125, a control signaling processing component 1130, a control signaling component 1135, a capability report component 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The control signaling component 1125 may be configured as or otherwise support a means for transmitting control signaling indicating a configuration for a UE to perform a machine learning-based inference for a characteristic of at least one resource, at least one communication beam, or at least one communication channel. The control signaling processing component 1130 may be configured as or otherwise support a means for receiving, in accordance with a triggering condition, an indication of a difference between the machine learning-based inference and a measurement of the characteristic for the at least one resource, the at least one communication beam, or the at least one communication channel at the UE.

In some examples, the indication of the difference between the machine learning-based inference and the measurement of the characteristic may include one or more of: a first set of identifiers corresponding to one or more resources having a highest predicted measurement of the characteristic of the at least one resource, the at least one communication beam, or the at least one communication channel, a second set of identifiers corresponding to one or more resources having a highest actual predicted measurement of the characteristic of the at least one resource, the at least one communication beam, or the at least one communication channel, an indication of a difference between the first set of identifiers and the second set of identifiers, or any combination thereof.

In some examples, the measurement of the characteristic may be a virtual measurement of a virtual resource associated with the characteristic of the at least one resource, the at least one communication beam, or the at least one communication channel, wherein the virtual resource may be a non-transmitted resource.

In some examples, to support transmitting the control signaling, the control signaling component 1135 may be configured as or otherwise support a means for transmitting an instruction to report the at least one historic value of the characteristic and the predicted at least one later value of the characteristic.

In some examples, to support receiving the indication of the difference between the machine learning-based inference and the measurement of the characteristic, the control signaling processing component 1130 may be configured as or otherwise support a means for receiving the at least one historic value of the characteristic and the predicted at least one later value of the characteristic in accordance with the transmitted instruction.

In some examples, to support wireless communications, the control signaling component 1135 may be configured as or otherwise support a means for transmitting an instruction to report the at least one historic value of the characteristic and the predicted at least one later value of the characteristic.

In some examples, the control signaling component 1135 may be configured as or otherwise support a means for transmitting an indication of a length of the time series of the set of multiple historic values of the characteristic.

In some examples, to support receiving the indication of the difference between the machine learning-based inference and the measurement of the characteristic, the control signaling processing component 1130 may be configured as or otherwise support a means for receiving an indication of a length of the time series of the set of multiple historic values of the characteristic.

In some examples, to support transmitting the control signaling, the control signaling component 1135 may be configured as or otherwise support a means for transmitting an instruction to report at least one first value of the characteristic associated with a first set of one or more reference signal resource identifiers or SSB resource identifiers and at least one predicted second value of the characteristic associated with a second set of one or more reference signal resource identifiers or SSB resource identifiers, where the machine learning-based inference includes the at least one predicted second value of the characteristic.

In some examples, to support receiving the indication of the difference between the machine learning-based inference and the measurement of the characteristic, the control signaling processing component 1130 may be configured as or otherwise support a means for receiving the at least one first value of the characteristic associated with the first set of one or more reference signal resource identifiers or SSB resource identifiers and the at least one predicted second value of the characteristic associated with the second set of one or more reference signal resource identifiers or SSB resource identifiers.

In some examples, the control signaling component 1135 may be configured as or otherwise support a means for transmitting an indication of the triggering condition.

In some examples, the capability report component 1140 may be configured as or otherwise support a means for receiving a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

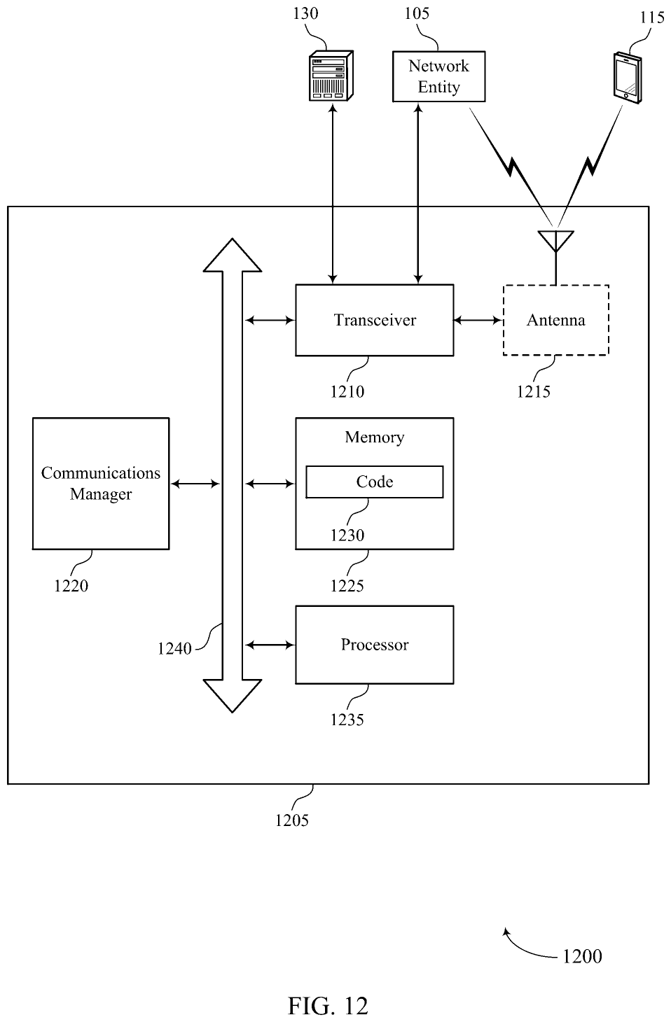

FIG. 12 shows a diagram of a system 1200 including a device 1205 that supports inference error information feedback for machine learning-based inferences in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting inference error information feedback for machine learning-based inferences). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting control signaling indicating a configuration for a UE to perform a machine learning-based inference for a characteristic of at least one resource, at least one communication beam, or at least one communication channel. The communications manager 1220 may be configured as or otherwise support a means for receiving, in accordance with a triggering condition, an indication of a difference between the machine learning-based inference and a measurement of the characteristic for the at least one resource, the at least one communication beam, or the at least one communication channel at the UE.

By including or configuring the communications manager 1220 in accordance with examples as described herein, the device 1205 may support techniques for improved communication reliability and improved user experience related to improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of inference error information feedback for machine learning-based inferences as described herein, or the processor 1235 and the memory 1225 may be otherwise configured to perform or support such operations.

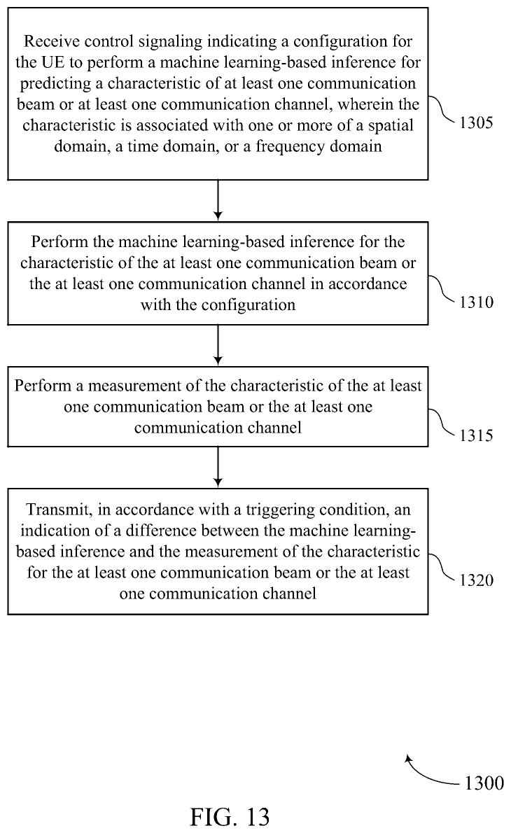

FIG. 13 shows a flowchart illustrating a method 1300 that supports inference error information feedback for machine learning-based inferences in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The operations of 1305 may be performed in accordance with examples as disclosed herein. In some examples, aspects of the operations of 1305 may be performed by a control signaling processing component 725 as described with reference to FIG. 7.

At 1310, the method may include performing the machine learning-based inference for the characteristic of the at least one resource, the at least one communication beam, or the at least one communication channel in accordance with the configuration. The operations of 1310 may be performed in accordance with examples as disclosed herein. In some examples, aspects of the operations of 1310 may be performed by a machine learning-based inference component 730 as described with reference to FIG. 7.

At 1315, the method may include obtain a measurement of the characteristic of the at least one resource, the at least one communication beam, or the at least one communication channel. In some cases, the method may include obtaining a virtual measurement of a virtual resource associated with the characteristic of the at least one resource, the at least one communication beam, or the at least one communication channel, wherein the virtual resource is a non-transmitted resource. The operations of 1315 may be performed in accordance with examples as disclosed herein. In some examples, aspects of the operations of 1315 may be performed by a measurement component 735 as described with reference to FIG. 7.

At 1320, the method may include transmitting, in accordance with a triggering condition, an indication of a difference between the machine learning-based inference and the measurement of the characteristic for the at least one resource, the at least one communication beam, or the at least one communication channel. The operations of 1320 may be performed in accordance with examples as disclosed herein. In some examples, aspects of the operations of 1320 may be performed by an inference error information component 740 as described with reference to FIG. 7.

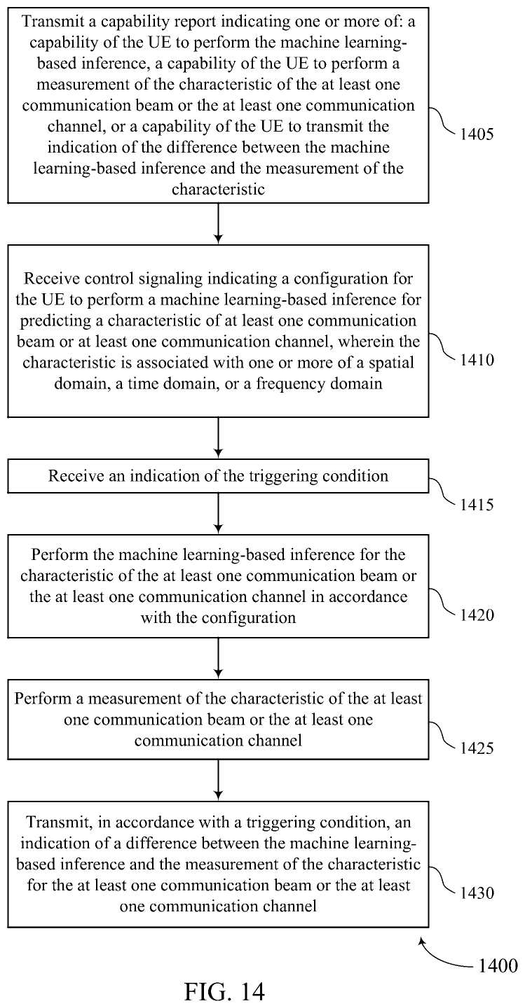

FIG. 14 shows a flowchart illustrating a method 1400 that supports inference error information feedback for machine learning-based inferences in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic. The operations of 1405 may be performed in accordance with examples as disclosed herein. In some examples, aspects of the operations of 1405 may be performed by a capability report component 745 as described with reference to FIG. 7.

At 1410, the method may include receiving control signaling indicating a configuration for the UE to perform a machine learning-based inference for a characteristic of at least one resource, at least one communication beam, or at least one communication channel, where the characteristic is associated with one or more of a spatial domain, a time domain, or a frequency domain. The operations of 1410 may be performed in accordance with examples as disclosed herein. In some examples, aspects of the operations of 1410 may be performed by a control signaling processing component 725 as described with reference to FIG. 7.

At 1415, the method may include receiving an indication of the triggering condition. The operations of 1415 may be performed in accordance with examples as disclosed herein. In some examples, aspects of the operations of 1415 may be performed by a control signaling processing component 725 as described with reference to FIG. 7.

At 1420, the method may include performing the machine learning-based inference for the characteristic of the at least one resource, the at least one communication beam, or the at least one communication channel in accordance with the configuration. The operations of 1420 may be performed in accordance with examples as disclosed herein. In some examples, aspects of the operations of 1420 may be performed by a machine learning-based inference component 730 as described with reference to FIG. 7.

At 1425, the method may include obtaining a measurement of the characteristic of the at least one resource, the at least one communication beam, or the at least one communication channel. In some cases, the method may include obtaining a virtual measurement of the virtual resource associated with the characteristic of the at least one resource, the at least one communication beam, or the at least one communication channel, where the virtual resource is a non-transmitted resource. The operations of 1425 may be performed in accordance with examples as disclosed herein. In some examples, aspects of the operations of 1425 may be performed by a measurement component 735 as described with reference to FIG. 7.

At 1430, the method may include transmitting, in accordance with a triggering condition, an indication of a difference between the machine learning-based inference and the measurement of the characteristic for the at least one resource, the at least one communication beam, or the at least one communication channel. The operations of 1430 may be performed in accordance with examples as disclosed herein. In some examples, aspects of the operations of 1430 may be performed by an inference error information component 740 as described with reference to FIG. 7.

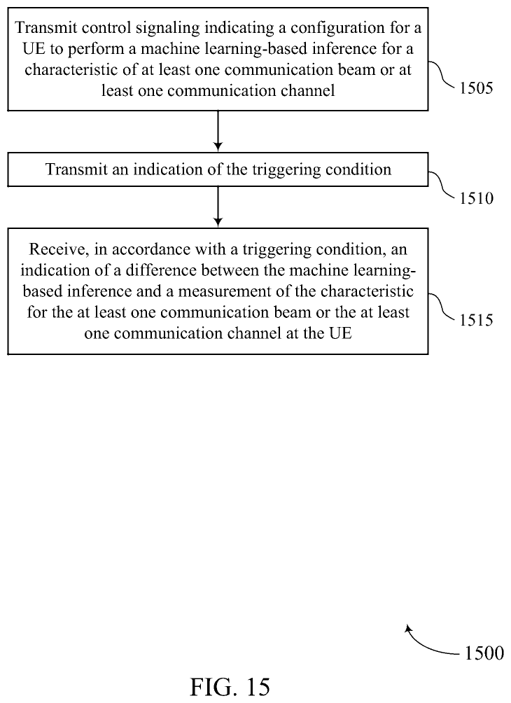

FIG. 15 shows a flowchart illustrating a method 1500 that supports inference error information feedback for machine learning-based inferences in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling indicating a configuration for a UE to perform a machine learning-based inference for a characteristic of at least one resource, at least one communication beam, or at least one communication channel. The operations of 1505 may be performed in accordance with examples as disclosed herein. In some examples, aspects of the operations of 1505 may be performed by a control signaling component 1125 as described with reference to FIG. 11.

At 1510, the method may include transmitting an indication of the triggering condition. The operations of 1510 may be performed in accordance with examples as disclosed herein. In some examples, aspects of the operations of 1510 may be performed by a control signaling component 1135 as described with reference to FIG. 11.

At 1515, the method may include receiving, in accordance with a triggering condition, an indication of a difference between the machine learning-based inference and a measurement of the characteristic for the at least one resource, the at least one communication beam, or the at least one communication channel at the UE. The operations of 1515 may be performed in accordance with examples as disclosed herein. In some examples, aspects of the operations of 1515 may be performed by a control signaling processing component 1130 as described with reference to FIG. 11.

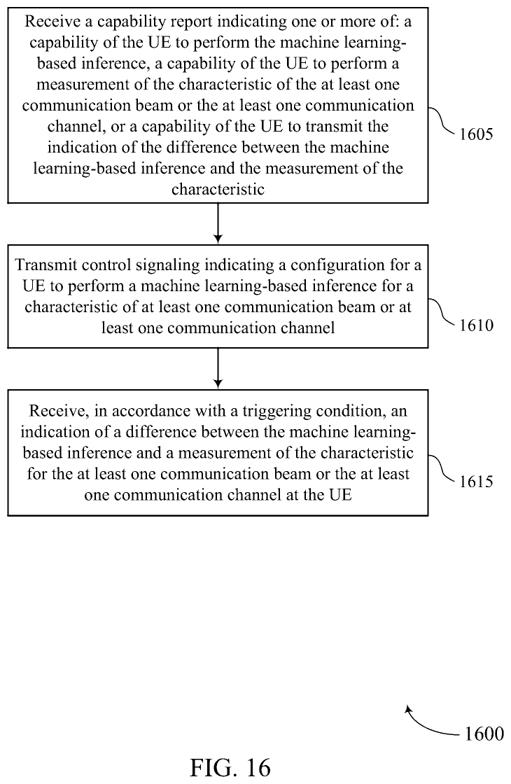

FIG. 16 shows a flowchart illustrating a method 1600 that supports inference error information feedback for machine learning-based inferences in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic. The operations of 1605 may be performed in accordance with examples as disclosed herein. In some examples, aspects of the operations of 1605 may be performed by a capability report component 1140 as described with reference to FIG. 11.

At 1610, the method may include transmitting control signaling indicating a configuration for a UE to perform a machine learning-based inference for a characteristic of at least one resource, at least one communication beam, or at least one communication channel. The operations of 1610 may be performed in accordance with examples as disclosed herein. In some examples, aspects of the operations of 1610 may be performed by a control signaling component 1125 as described with reference to FIG. 11.

At 1615, the method may include receiving, in accordance with a triggering condition, an indication of a difference between the machine learning-based inference and a measurement of the characteristic for the at least one resource, the at least one communication beam, or the at least one communication channel at the UE. The operations of 1615 may be performed in accordance with examples as disclosed herein. In some examples, aspects of the operations of 1615 may be performed by a control signaling processing component 1130 as described with reference to FIG. 11.

The following provides an overview of aspects of the present disclosure:

Aspect 1: A method for wireless communication at a UE, comprising: receiving control signaling indicating a configuration for the UE to perform a machine learning-based inference for a characteristic of at least one resource, at least one communication beam, or at least one communication channel, wherein the characteristic is associated with one or more of a spatial domain, a time domain, or a frequency domain; performing the machine learning-based inference for the characteristic of the at least one resource, the at least one communication beam, or the at least one communication channel in accordance with the configuration; performing a measurement of the characteristic of the at least one resource, the at least one communication beam, or the at least one communication channel; and transmitting, in accordance with a triggering condition, an indication of a difference between the machine learning-based inference and the measurement of the characteristic for the at least one resource, the at least one communication beam, or the at least one communication channel.

Aspect 2: The method of aspect 1, wherein performing the machine learning-based inference for the characteristic of the at least one resource, the at least one communication beam, or the at least one communication channel comprises: identifying, based at least in part on the machine learning-based inference, a first set of identifiers corresponding to one or more resources having a highest predicted measurement of the characteristic of the at least one resource, the at least one communication beam, or the at least one communication channel; and identifying, based at least in part on obtaining the measurement of the characteristic, a second set of identifiers corresponding to one or more resources having a highest actual predicted measurement of the characteristic of the at least one resource, the at least one communication beam, or the at least one communication channel.

Aspect 3: The method of aspect 2, wherein transmitting the indication of a difference between the machine learning-based inference and the measurement of the characteristic of the at least one resource, the at least one communication beam, or the at least one communication channel comprises: transmitting one or more of: the first set of identifiers, the second set of identifiers, an indication of a difference between the first set of identifiers and the second set of identifiers, or any combination thereof.

Aspect 4: The method of aspect 1, wherein obtaining the measurement of the characteristic of the at least one resource, the at least one communication beam, or the at least one communication channel comprises: obtaining a virtual measurement of a virtual resource associated with the characteristic of the at least one resource, the at least one communication beam, or the at least one communication channel, wherein the virtual resource is a non-transmitted resource.

Aspect 5: The method of aspect 1, wherein performing the machine learning-based inference for the characteristic of the at least one resource, the at least one communication beam, or the at least one communication channel comprises: applying a machine learning model to at least one historic value of the characteristic to predict at least one later value of the characteristic, wherein the machine learning-based inference comprises the predicted at least one later value of the characteristic.

Aspect 6: The method of aspect 5, wherein receiving the control signaling comprises: receiving an instruction to report the at least one historic value of the characteristic and the predicted at least one later value of the characteristic.

Aspect 7: The method of aspect 6, wherein transmitting the indication of the difference between the machine learning-based inference and the measurement of the characteristic comprises: transmitting the at least one historic value of the characteristic and the predicted at least one later value of the characteristic in accordance with the received instruction.

Aspect 8: The method of any of aspects 5 through 7, wherein the at least one historic value of the characteristic comprises a time series of a plurality of historic values of the characteristic.

Aspect 9: The method of aspect 8, further comprising: receiving an indication of a length of the time series of the plurality of historic values of the characteristic.

Aspect 10: The method of any of aspects 8 through 9, wherein transmitting the indication of the difference between the machine learning-based inference and the measurement of the characteristic comprises: transmitting an indication of a length of the time series of the plurality of historic values of the characteristic.

Aspect 11: The method of any of aspects 1 through 10, wherein performing the machine learning-based inference for the characteristic of the at least one resource, the at least one communication beam, or the at least one communication channel comprises: applying a machine learning model to at least one first value of the characteristic associated with a first set one or more reference signal resource identifiers or SSB resource identifiers to predict at least one second value of the characteristic associated with a second set of one or more reference signal resource identifiers or SSB resource identifiers, wherein the machine learning-based inference comprises the predicted at least one second value of the characteristic.

Aspect 12: The method of aspect 11, wherein the first set of one or more reference signal resource identifiers or SSB resource identifiers is spatially different than the second set of one or more reference signal resource identifiers or SSB resource identifiers.

Aspect 13: The method of any of aspects 11 through 12, wherein the first set of one or more reference signal resource identifiers or SSB resource identifiers and the second set of one or more reference signal resource identifiers or SSB resource identifiers are associated with different bandwidth parts or serving cells.

Aspect 14: The method of any of aspects 11 through 13, wherein receiving the control signaling comprises: receiving an instruction to report the at least one first value of the characteristic associated with the first set one or more reference signal resource identifiers or SSB resource identifiers and the at least one second value of the characteristic associated with the second set of one or more reference signal resource identifiers or SSB resource identifiers.

Aspect 15: The method of aspect 14, wherein transmitting the indication of the difference between the machine learning-based inference and the measurement of the characteristic comprises: transmitting the at least one first value of the characteristic associated with the first set one or more reference signal resource identifiers or SSB resource identifiers and the at least one second value of the characteristic associated with the second set of one or more reference signal resource identifiers or SSB resource identifiers.

Aspect 16: The method of any of aspects 1 through 15, further comprising: receiving an indication of the triggering condition.

Aspect 17: The method of any of aspects 1 through 16, wherein the triggering condition occurs when the difference between the machine learning-based inference and the measurement of the characteristic satisfies a threshold.

Aspect 18: The method of any of aspects 1 through 17, further comprising: transmitting a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

Aspect 19: The method of any of aspects 1 through 18, wherein the characteristic comprises one or more of: a signal strength associated with the at least one communication channel or the at least one communication beam, a change in signal strength associated with the at least one communication channel or the at least one communication beam, an explicit channel characteristic associated with the at least one resource, the at least one communication beam, or the at least one communication channel, an angular characteristic associated with the at least one resource, the at least one communication beam, or the at least one communication channel, a location of the UE during communication over the at least one resource, the at least one communication beam, or the at least one communication channel, a set of one or more UE receive beams used to communicate over the at least one resource, the at least one communication beam, or the at least one communication channel, a bandwidth part identifier associated with communicating over the at least one resource, the at least one communication beam, or the at least one communication channel, a serving cell identifier associated with communicating over the at least one resource, the at least one communication beam, or the at least one communication channel, a central frequency associated with communicating over the at least one resource, the at least one communication beam, or the at least one communication channel, or a numerology associated with communicating over the at least one resource, the at least one communication beam, or the at least one communication channel.

Aspect 20: The method of any of aspects 1 through 19, wherein the characteristic is defined with respect to a set of one or more reference signal resource sets or one or more SSB resource sets.

Aspect 21: The method of any of aspects 1 through 20, wherein the indication of the difference between the machine learning-based inference and the measurement of the characteristic is transmitted via one or more of an application layer protocol, a radio resource control layer, or a medium access control layer, the indication comprising physical layer information associated with the machine learning-based inference.

Aspect 22: The method of any of aspects 1 through 21, wherein the indication of the difference between the machine learning-based inference and the measurement of the characteristic is transmitted in a channel state information report via a physical layer uplink control information transmission.

Aspect 23: The method of any of aspects 1 through 22, wherein transmitting the indication of the difference between the machine learning-based inference and the measurement of the characteristic comprises: transmitting an indication of a state of one or more hidden layers of a machine learning model associated with the machine learning-based inference.

Aspect 24: A method for wireless communication at a network entity, comprising: transmitting control signaling indicating a configuration for a UE to perform a machine learning-based inference for a characteristic of at least one resource, at least one communication beam, or at least one communication channel; and receiving, in accordance with a triggering condition, an indication of a difference between the machine learning-based inference and a measurement of the characteristic for the at least one resource, the at least one communication beam, or the at least one communication channel at the UE.

Aspect 25: The method of aspect 24, wherein the machine learning-based inference comprises at least one predicted later value of the characteristic based at least in part on at least one historic value of the characteristic, and wherein transmitting the control signaling comprises: transmitting an instruction to report the at least one historic value of the characteristic and the predicted at least one later value of the characteristic.

Aspect 26: The method of aspect 25, wherein receiving the indication of the difference between the machine learning-based inference and the measurement of the characteristic comprises: receiving the at least one historic value of the characteristic and the predicted at least one later value of the characteristic in accordance with the transmitted instruction.

Aspect 27: The method of any of aspects 25 through 26, wherein the at least one historic value of the characteristic comprises a time series of a plurality of historic values of the characteristic, and further comprising: transmitting an instruction to report the at least one historic value of the characteristic and the predicted at least one later value of the characteristic.

Aspect 28: The method of aspect 27, further comprising: transmitting an indication of a length of the time series of the plurality of historic values of the characteristic.

Aspect 29: The method of any of aspects 27 through 28, wherein receiving the indication of the difference between the machine learning-based inference and the measurement of the characteristic comprises: receiving an indication of a length of the time series of the plurality of historic values of the characteristic.

Aspect 30: The method of any of aspects 24 through 29, wherein transmitting the control signaling comprises: transmitting an instruction to report at least one first value of the characteristic associated with a first set of one or more reference signal resource identifiers or SSB resource identifiers and at least one predicted second value of the characteristic associated with a second set of one or more reference signal resource identifiers or SSB resource identifiers, wherein the machine learning-based inference comprises the at least one predicted second value of the characteristic.

Aspect 31: The method of aspect 30, wherein receiving the indication of the difference between the machine learning-based inference and the measurement of the characteristic comprises: receiving the at least one first value of the characteristic associated with the first set of one or more reference signal resource identifiers or SSB resource identifiers and the at least one predicted second value of the characteristic associated with the second set of one or more reference signal resource identifiers or SSB resource identifiers.

Aspect 32: The method of any of aspects 24 through 31, further comprising: transmitting an indication of the triggering condition.

Aspect 33: The method of any of aspects 24 through 32, further comprising: receiving a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

Aspect 34: An apparatus for wireless communication at a UE, comprising a processor; memory coupled with the processor; and instructions stored in the memory and executable by the processor to cause the apparatus to perform a method of any of aspects 1 through 23.

Aspect 35: An apparatus for wireless communication at a UE, comprising at least one means for performing a method of any of aspects 1 through 23.

Aspect 36: A non-transitory computer-readable medium storing code for wireless communication at a UE, the code comprising instructions executable by a processor to perform a method of any of aspects 1 through 23.

Aspect 37: An apparatus for wireless communication at a network entity, comprising a processor; memory coupled with the processor; and instructions stored in the memory and executable by the processor to cause the apparatus to perform a method of any of aspects 24 through 33.

Aspect 38: An apparatus for wireless communication at a network entity, comprising at least one means for performing a method of any of aspects 24 through 33.

Aspect 39: A non-transitory computer-readable medium storing code for wireless communication at a network entity, the code comprising instructions executable by a processor to perform a method of any of aspects 24 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
receive control signaling indicating a configuration for the UE to perform a machine learning-based inference for a characteristic of at least one resource, at least one communication beam, or at least one communication channel, wherein the characteristic is associated with one or more of a spatial domain, a time domain, or a frequency domain;
perform the machine learning-based inference for the characteristic of the at least one resource, the at least one communication beam, or the at least one communication channel in accordance with the configuration;
obtain a measurement of the characteristic of the at least one resource, the at least one communication beam, or the at least one communication channel; and
transmit, in accordance with a triggering condition, an indication of a difference between the machine learning-based inference and the measurement of the characteristic for the at least one resource, the at least one communication beam, or the at least one communication channel.

2. The apparatus of claim 1, wherein to perform the machine learning-based inference for the characteristic and to obtain the measurement of the characteristic, the instructions are further executable by the at least one processor to cause the UE to:
identify, based at least in part on the machine learning-based inference, a first set of identifiers corresponding to one or more resources having a highest predicted measurement of the characteristic of the at least one resource, the at least one communication beam, or the at least one communication channel; and
identify, based at least in part on obtaining the measurement of the characteristic, a second set of identifiers corresponding to one or more resources having a highest actual predicted measurement of the characteristic of the at least one resource, the at least one communication beam, or the at least one communication channel.

3. The apparatus of claim 2, wherein to transmit the indication of a difference between the machine learning-based inference and the measurement of the characteristic, the instructions are further executable by the at least one processor to cause the UE to:
transmit one or more of: the first set of identifiers, the second set of identifiers, an indication of a difference between the first set of identifiers and the second set of identifiers, or any combination thereof.

4. The apparatus of claim 1, wherein to obtain the measurement of the characteristic, the instructions are further executable by the at least one processor to cause the UE to:
obtain a virtual measurement of a virtual resource associated with the characteristic of the at least one resource, the at least one communication beam, or the at least one communication channel, wherein the virtual resource is a non-transmitted resource.

5. The apparatus of claim 1, wherein the instructions to perform the machine learning-based inference for the characteristic of the at least one resource, the at least one communication beam, or the at least one communication channel are executable by the at least one processor to cause the UE to:
apply a machine learning model to at least one historic value of the characteristic to predict at least one later value of the characteristic, wherein the machine learning-based inference comprises the predicted at least one later value of the characteristic.

6. The apparatus of claim 5, wherein the instructions to receive the control signaling are executable by the at least one processor to cause the UE to:
receive an instruction to report the at least one historic value of the characteristic and the predicted at least one later value of the characteristic.

7. The apparatus of claim 6, wherein the instructions to transmit the indication of the difference between the machine learning-based inference and the measurement of the characteristic are executable by the at least one processor to cause the UE to:
transmit the at least one historic value of the characteristic and the predicted at least one later value of the characteristic in accordance with the received instruction.

8. The apparatus of claim 5, wherein the at least one historic value of the characteristic comprises a time series of a plurality of historic values of the characteristic.

9. The apparatus of claim 8, wherein the instructions are further executable by the at least one processor to cause the UE to:
receive an indication of a length of the time series of the plurality of historic values of the characteristic.

10. The apparatus of claim 8, wherein the instructions to transmit the indication of the difference between the machine learning-based inference and the measurement of the characteristic are executable by the at least one processor to cause the UE to:
transmit an indication of a length of the time series of the plurality of historic values of the characteristic.

11. The apparatus of claim 1, wherein the instructions to perform the machine learning-based inference for the characteristic of the at least one resource, the at least one communication beam, or the at least one communication channel are executable by the at least one processor to cause the UE to:
apply a machine learning model to at least one first value of the characteristic associated with a first set one or more reference signal resource identifiers or synchronization signal block resource identifiers to predict at least one second value of the characteristic associated with a second set of one or more reference signal resource identifiers or synchronization signal block resource identifiers, wherein the machine learning-based inference comprises the predicted at least one second value of the characteristic.

12. The apparatus of claim 11, wherein the first set of some or more reference signal resource identifiers or synchronization signal block resource identifiers is spatially different than the second set of one or more reference signal resource identifiers or synchronization signal block resource identifiers.

13. The apparatus of claim 11, wherein the first set of one or more reference signal resource identifiers or synchronization signal block resource identifiers and the second set of one or more reference signal resource identifiers or synchronization signal block resource identifiers are associated with different bandwidth parts or serving cells.

14. The apparatus of claim 11, wherein the instructions to receive the control signaling are executable by the at least one processor to cause the UE to:
receive an instruction to report the at least one first value of the characteristic associated with the first set one or more reference signal resource identifiers or synchronization signal block resource identifiers and the at least one second value of the characteristic associated with the second set of one or more reference signal resource identifiers or synchronization signal block resource identifiers.

15. The apparatus of claim 14, wherein the instructions to transmit the indication of the difference between the machine learning-based inference and the measurement of the characteristic are executable by the at least one processor to cause the UE to:
transmit the at least one first value of the characteristic associated with the first set one or more reference signal resource identifiers or synchronization signal block resource identifiers and the at least one second value of the characteristic associated with the second set of one or more reference signal resource identifiers or synchronization signal block resource identifiers.

16. The apparatus of claim 1, wherein the instructions are further executable by the at least one processor to cause the UE to:
receive an indication of the triggering condition.

17. The apparatus of claim 1, wherein the triggering condition occurs when the difference between the machine learning-based inference and the measurement of the characteristic satisfies a threshold.

18. The apparatus of claim 1, wherein the instructions are further executable by the at least one processor to cause the UE to:
transmit a capability report indicating one or more of: a capability of the UE to perform the machine learning-based inference, a capability of the UE to perform a measurement of the characteristic of the at least one resource, the at least one communication beam, or the at least one communication channel, or a capability of the UE to transmit the indication of the difference between the machine learning-based inference and the measurement of the characteristic.

19. The apparatus of claim 1, wherein the characteristic comprises one or more of a signal strength associate with the at least one communication channel or the at least one communication beam, a change in signal strength associated with the at least one communication channel or the at least one communication beam, an explicit channel characteristic associated with the at least one resource, the at least one communication beam, or the at least one communication channel, an angular characteristic associated with the at least one resource, the at least one communication beam, or the at least one communication channel, a location of the UE during communication over the at least one resource, the at least one communication beam, or the at least one communication channel, a set of one or more UE receive beams used to communicate over the at least one resource, the at least one communication beam, or the at least one communication channel, a bandwidth part identifier associated with communicating over the at least one resource, the at least one communication beam, or the at least one communication channel, a serving cell identifier associated with communicating over the at least one resource, the at least one communication beam, or the at least one communication channel, a central frequency associated with communicating over the at least one resource, the at least one communication beam, or the at least one communication channel, or a numerology associated with communicating over the at least one resource, the at least one communication beam, or the at least one communication channel.

20. The apparatus of claim 1, wherein the characteristic is defined with respect to a set of one or more reference signal resource sets or one or more synchronization block resource sets.

21. The apparatus of claim 1, wherein the indication of the difference between the machine learning-based inference and the measurement of the characteristic is transmitted via one or more of an application layer protocol, a radio resource control layer, or a medium access control layer, the indication comprising physical layer information associated with the machine learning-based inference.

22. The apparatus of claim 1, wherein the indication of the difference between the machine learning-based inference and the measurement of the characteristic is transmitted in a channel state information report via a physical layer uplink control information transmission.

23. The apparatus of claim 1, wherein the instructions to transmit the indication of the difference between the machine learning-based inference and the measurement of the characteristic are executable by the at least one processor to cause the UE to:
transmit an indication of a state of one or more hidden layers of a machine learning model associated with the machine learning-based inference.

24. An apparatus for wireless communication at a network entity, comprising:
at least one processor; and
memory coupled with the at least one processor, the memory storing instructions executable by the at least one processor to cause the network entity to:
transmit control signaling indicating a configuration for a user equipment (UE) to perform a machine learning-based inference for a characteristic of at least one resource, at least one communication beam, or at least one communication channel; and
receive, in accordance with a triggering condition, an indication of a difference between the machine learning-based inference and a measurement of the characteristic for the at least one resource, the at least one communication beam, or the at least one communication channel at the UE.

25. The apparatus of claim 24, wherein the indication of the difference between the machine learning-based inference and the measurement of the characteristic comprises one or more of: a first set of identifiers corresponding to one or more resources having a highest predicted measurement of the characteristic of the at least one resource, the at least one communication beam, or the at least one communication channel, a second set of identifiers corresponding to one or more resources having a highest actual predicted measurement of the characteristic of the at least one resource, the at least one communication beam, or the at least one communication channel, an indication of a difference between the first set of identifiers and the second set of identifiers, or any combination thereof.

26. The apparatus of claim 24, wherein the measurement of the characteristic is a virtual measurement of a virtual resource associated with the characteristic of the at least one resource, the at least one communication beam, or the at least one communication channel, wherein the virtual resource is a non-transmitted resource.

27. The apparatus of claim 24, wherein the machine learning-based inference comprises at least one predicted later value of the characteristic based at least in part on at least one historic value of the characteristic, and wherein the instructions to transmit the control signaling are executable by the at least one processor to cause the network entity to:
transmit an instruction to report the at least one historic value of the characteristic and the predicted at least one later value of the characteristic.

28. The apparatus of claim 27, wherein the instructions to receive the indication of the difference between the machine learning-based inference and the measurement of the characteristic are executable by the at least one processor to cause the network entity to:
receive the at least one historic value of the characteristic and the predicted at least one later value of the characteristic in accordance with the transmitted instruction.

29. The apparatus of claim 24, wherein the instructions to transmit the control signaling are executable by the at least one processor to cause the network entity to:
transmit an instruction to report at least one first value of the characteristic associated with a first set of one or more reference signal resource identifiers or synchronization signal block resource identifiers and at least one predicted second value of the characteristic associated with a second set of one or more reference signal resource identifiers or synchronization signal block resource identifiers, wherein the machine learning-based inference comprises the at least one predicted second value of the characteristic.

30. The apparatus of claim 29, wherein the instructions to receive the indication of the difference between the machine learning-based inference and the measurement of the characteristic are executable by the at least one processor to cause the network entity to:
receive the at least one first value of the characteristic associated with the first set of one or more reference signal resource identifiers or synchronization signal block resource identifiers and the at least one predicted second value of the characteristic associated with the second set of one or more reference signal resource identifiers or synchronization signal block resource identifiers.
